(19) United States
(12) Patent Application Publication
(10) Pub. No.: US 2013/0133250 A1
(43) Pub. Date: May 30, 2013

(54) System and Method for Removing Contaminants in Liquids

(71) Applicant: Dr. T Limited, Hong Kong (HK)

(72) Inventor: Kar Ki Chan, Hong Kong (HK)

(73) Assignee: DR. T LIMITED, Hong Kong (HK)

(21) Appl. No.: 13/666,962

(22) Filed: Nov. 1, 2012

(30) Foreign Application Priority Data
Nov. 18, 2011 (CN) 201110368785.4

(51) Int. Cl. B04B 11/04; A01K 63/04

(52) U.S. Cl. CPC B04B 11/04; A01K 63/045
USPC 47/1.4; 494/52; 494/36; 494/53; 494/4; 494/2; 494/10; 119/260

(57) ABSTRACT

A fluid filtration system using a rotating container, comprising a shell having an inlet pipe installation port and an outlet port, the inlet pipe installation port and the outlet port are located on the same or opposite side (end) of the shell, and having some distance from the outermost edge of the shell, such that said rotating container can retain fluid during rotation. Stirring blades are placed inside the shell of said rotating container, which rotate with the shell synchronously. The purification process includes the injection of the fluid into the rotating container, which can withhold liquid during high-speed rotation. When the fluid in the rotating container swirls at high speed, substances of higher densities will accumulate at the internal wall of the rotating container away from the rotation axis, whereas substances of lower densities will accumulate at the inner ring region closer to the rotation axis.

### CLAIM FOR FOREIGN PRIORITY

This application claims priority under 35 U.S.C. §119 to the China Patent for Invention Application No. 201110368785.4 filed Nov. 18, 2011, the disclosure of which is incorporated herein by reference in its entirety.

### FIELD OF THE INVENTION

The presently claimed invention generally relates to fluid filtration using the rotating container, particularly to a rotating container which separates the substances of high or low mass density from fluid. The presently claimed invention can be used to purify water, air, contaminated seawater, plasma and other fluids. In addition, one embodiment, where a reverse osmosis membrane is properly installed, can also be used for seawater desalination.

### BACKGROUND

In manufacturing, water treatment, gas purification, and many other areas of heavy industry, it is necessary to filter the liquids, gases, plasma and other fluids mixed with impurities. Substances of certain mass density are filtered out from the liquids, gases, or plasma so as to achieve the purpose of fluid purification or impurities extraction for certain purposes. There are many examples of impurities such as suspended particulates in the emissions of factories and motor vehicles, dust in the atmosphere, organic pollutants, gases, oil, radioactive materials, algae, proteins, bacteria and viruses in water, metal ions and particles in the gases and plasma emitted from garbage incinerators.

Existing fluid filtration systems often use filter materials for physical filtration, such as filter core and filter screen. Using this method, the filter materials are clogged by pollutants after a period of time of use and must be replaced or cleaned. To filter small contaminants, the mesh of filter materials has to be very small, which increases the chance of clogging, thus shorten the useful lifespan of filter materials. Therefore, there is a need for a better fluid filter, which can filter impurities from fluid without the aforementioned shortcomings.

### SUMMARY

It is an objective of the presently claimed invention to provide a rotating container and the fluid filtration system using the rotating container and their methods of operation addressing the need for a better fluid filter.

To more clearly illustrate the presently claimed invention, this document uses the following definitions:
Maximum axial distance: the maximum distance measured from a hole or opening to the rotation axis. For example, in the case where a rotation axis is located at the center of a square hole, the maximum axial distance is half the length of the diagonal of the square hole.
Periphery: the position far away from the rotation axis inside a rotating container. With respect to the periphery of an object, it should be understood as: the position far away from the rotation axis when the object is placed inside the rotating container.
Heavy impurity: The higher mass density impurities in the fluid to be purified.
Light impurities: The lighter lower mass density impurities in the fluid to be purified.
Inlet chamber: A chamber in the rotating container; in the chamber, the flow direction of fluid is generally away from the rotation axis.
Outlet chamber: A chamber in the rotating container; in the chamber, the flow direction of fluid is generally toward to the rotation axis.

Firstly, the presently claimed invention provides a rotating container, comprising a shell, the shell has an inlet pipe installation port for installing the inlet pipe and an outlet port. The inlet pipe installation port and the outlet port are located on the same or opposite side (end) of the shell, and have some distance from the outermost edge of the shell, so that the rotating container can store water during rotation. The inlet pipe installation port can let an inlet pipe, which is fixed on the housing of the rotating container, passing through it (without touching the rotating container) for inputting fluid. The maximum axial distance of the inlet pipe installation port is smaller than that of the outlet port; stirring blades are placed inside the shell of the rotating container, which rotate with the shell synchronously. The stirring blades can be of planar or curved shape, in generally, the best choice is the spiral stirring blades. With respect to the control means of water flow inside the rotating container, the internal design of the rotating container is further divided into three categories, including: Category A: No difference between inlet chamber and outlet chamber; Category B: A flow-return partition is used to separate the inlet chamber and outlet chamber; Category C: Similar to Category A rotating container, but with an outlet pipe or an outlet passage structure with one end connecting the outlet port.

The presently claimed invention also includes a drain hole, which is implemented on the rotating container and the drain action is controlled by a flexible valve. The invention provides two flexible valve designs, including lever-type and piston-type structures.

Moreover, the presently claimed invention also provides a fluid filtration device, characterized in that the fluid filtration device includes the rotating container, a housing or support structure for fixing (here means fixing the motor system which is attached directly on the rotating container or using bearings to fix the rotating container on the housing or supporting structure) the said rotating container, an inlet pipe fixed on the housing or the support structure, and a motor system driving the rotating container.

Furthermore, the presently claimed invention also provides another fluid filtration device, characterized in that the fluid filtration device includes the rotating container, the housing or support structure fixing (the same meaning as that mentioned previously) the rotating container, a synchronous inlet pipe which is attached on the rotating container and aligned with the rotation axis, and a motor system driving the rotating container.

The presently claimed invention also provides a synchronous centrifugal pump structure, whose structure is that stirring blades are installed inside the circularly symmetric pipe, one end of the circularly symmetric pipe has a circular cover, the circular cover has a hole in the center for fluid inflow, the circularly symmetric pipe, the circular cover and the stirring blades rotate synchronously.

The presently claimed invention also provides a self-cleaning aquaculture system, including at least one said filtration device, which works with at least one algae culturing tank and at least one aquaculture tank; the filtration device draws water from the algae culturing tank and after filtering, the filtered water is infused into the aquaculture tank; there is a water return passage between the algae culturing tank and the aquaculture tank, enabling the water in the aquaculture tank water to flow back into the algae culturing tank.

The presently claimed invention also provides a reverse osmosis filtration system, including the rotating container with the filter core, and the filter core includes a reverse osmosis membrane.

The presently claimed invention further makes uses the two types of fluid filtration devices in combination with the rotating container made of transparent material and the drain hole is controlled via a flexible valve; a photo-sensor is also used for real-time monitoring of the accumulated impurities in the rotating container. This accomplishes a filtration device which can automatically cleanup the heavy or light impurities accumulated in the rotating container.

Through making use of the rotating container and the fluid filtration devices of the presently claimed invention, the fluid in the rotating container can be effectively purified, and the impurities can be separated from the fluid; moreover, centrifugal force is used to separate heavy impurities from light impurities, so as to store them in different locations inside the container for convenient collection.

In addition to liquid purification or separation, the presently claimed invention can also be used for gas and plasma purification or separation.

### BRIEF DESCRIPTION OF THE DRAWINGS

Embodiments of the invention are described in more details hereinafter with reference to the drawings, in which:

FIG. 1 shows an elevation view of an embodiment of a rotating container of the presently claimed invention, wherein the outlet port and the inlet pipe installation opening are located on the same side of the rotating container and these two ports are combined into one combined port;

FIG. 2 shows a top view of the embodiment of the rotating container of FIG. 1;

FIG. 3 shows a sectional view of an embodiment of a fluid filtration system of the presently claimed invention, wherein an outlet port and an inlet pipe installation port are located on different sides of the rotating container;

FIG. 4 shows a sectional view of another embodiment of a fluid filtration device of the presently claimed invention, wherein a fixed (fixed on the housing) inlet pipe draws the fluid into the rotating container;

FIG. 5 shows a top view of an embodiment of a rotating container of the presently claimed invention with spiral stirring blades;

FIG. 6 shows a schematic diagram and a top view of an embodiment of a Category B rotating container of the invention;

FIG. 7 shows a modification of the embodiment of the Category B rotating container of FIG. 6, wherein the inlet chamber is replaced with inlet conducting tube;

FIG. 8 shows a modification of the embodiment of the Category B rotating container of FIG. 6, wherein the outlet chamber is replaced with an outlet conducting tube;

FIG. 9 shows an embodiment of a Category C rotating container of the presently claimed invention, wherein an outlet passage structure is included;

FIG. 10 shows another embodiment of a Category C rotating container of the presently claimed invention, wherein an outlet passage structure is included and partitions with holes are used as stirring blades;

FIG. 11 shows yet another embodiment of a Category C rotating container of the presently claimed invention, wherein outlet conducting tubes are included;

FIG. 12 shows an embodiment of a Category B rotating container with a ceramic filter core;

FIG. 13 shows an embodiment of a Category B parallel multi-chamber rotating container;

FIG. 14 shows an embodiment of a Category B serial multi-chamber rotating container;

FIG. 15 shows a modification of the embodiment shown in FIG. 13, wherein some of the outlet chambers are replaced with outlet conducting tubes;

FIG. 16 shows a modification of the embodiment shown in FIG. 14, wherein some of the outlet chambers are replaced with outlet conducting tubes;

FIG. 17 shows an embodiment of a Category B rotating container with impurity storage space and planar stirring blades;

FIG. 18 shows an embodiment of a Category C rotating container with impurity storage space and planar stirring blades;

FIG. 19 shows an embodiment of a Category B rotating container with impurity storage space and two spiral stirring blades;

FIG. 20 shows an embodiment of a Category B rotating container with impurity storage space and four spiral stirring blades;

FIG. 21 shows an embodiment of a Category C rotating container with impurity storage space and spiral stirring blades;

FIG. 22 shows an embodiment of a rotating container which interior is not symmetric;

FIG. 23 shows an embodiment of a Category B rotating container without impurity storage space but with four spiral stirring blades;

FIG. 24 shows an embodiment of a Category C rotating container without impurity storage space but with spiral stirring blades;

FIG. 25 shows a modification of the embodiment of the rotating container shown in FIG. 20, which the impurity storage space is reinforced with axial reinforcement bars;

FIG. 26 shows an embodiment of a rotating container which shell can be detached;

FIG. 27 shows a structural diagram of an embodiment of a lever-type flexible valve of the presently claimed invention;

FIG. 28 shows a structural diagram of another embodiment of a lever-type flexible valve of the presently claimed invention, wherein a drain pipe is used to transfer the position of the effective drain hole closer to the rotation axis;

FIG. 29 shows a structural diagram of an embodiment of a piston-type flexible valve of the presently claimed invention;

FIG. 30 shows an embodiment of a rotating container with synchronous inlet pipe;

FIG. 31 shows an embodiment of a rotating container with small stirring blades, wherein the small stirring blades can be combined with the fixed inlet pipe to form a centrifugal pump structure;

FIG. 32 shows an embodiment of a liquid purification device with rotating container where a synchronous pump is implemented according to the presently claimed invention;

FIG. 33 shows an embodiment of a seawater and oil separation device of the presently claimed invention;

FIG. 34 shows an embodiment of an external hanging type purification device of the presently claimed invention;

FIG. 35 shows an embodiment of a self-cleaning aquaculture system of the presently claimed invention, in which the external hanging type purification device is fundamentally same as that illustrated in FIG. 34;

FIG. 36 shows an embodiment of a top-mounted purification device of the presently claimed invention; and

FIG. 37 shows an embodiment of a filtration system using a reverse osmosis membrane according to the presently claimed invention.

### DETAILED DESCRIPTION

In the following description, methods and systems for removing contaminants in liquids, gas, and plasma are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation. Although the preferred embodiments disclosed herein are applicable in removing contaminants in liquids, design adjustments and interpretations are made for applications on gas and plasma.

According to one embodiment of the presently claimed invention, there is at least one inlet pipe install installation port for a inlet pipe injecting fluid, i.e. liquid, into a rotating container spinning in high-speed. Stirring blades are installed inside the rotating container to ensure the fluid rotates with the rotating container synchronously. Heavy impurities in the liquid will accumulate in a location inside the rotating container farthest from the rotation axis, whereas the light impurities will accumulate in a location inside the rotating near the rotation axis of the rotating container.

According to one embodiment of the presently claimed invention, the rotating container has at least one outlet port. In general, the maximum axial distance of the inlet pipe installation port is smaller than that of the outlet port. When the rotating container rotates at high speed, the liquid will flow in and replenish the rotating container in a radial manner (from large radius position to small radius position) until it reaches the position that defined the maximum axial distance of the outlet port, and then the liquid will begin to overflow from the outlet port. The overflowed water will be scattered at high speed, and discharged directly or discharged after being filtered. Under the action of centrifugal force, the substances of different mass densities in the liquid will be separated in the rotating container. The heavy impurities will eventually accumulate at the internal wall of the rotating container away from the rotation axis, whereas the light impurities will accumulate at the inner ring region closer to the rotation axis.

The effects are not the same for the application to gas or plasma (for example, unlike liquid, gas does not replenish the rotating container in aforementioned radial manner until it reaches the outlet port). However, there is no significant difference in the primary feature of the presently claimed invention, that is, the rotating container structure.

Rotating Container

FIG. 1 shows the rotating container according to one embodiment of the presently claimed invention. In this embodiment, the rotating container 4 can rotate at high speed and can contain liquid. Four stirring blades 5 are set inside the rotating container 4, enabling the liquid (not shown in the drawing) to swirl along with the rotating container 4 synchronously. The inlet pipe T is placed at the inlet pipe installation port. In general, the maximum axial distance of the inlet pipe installation port for placing the inlet pipe is smaller than that of the outlet port 7. This arrangement allows the liquid to flow out from the outlet port 7 firstly under normal operation. In the application to gas or plasma, this arrangement can also ensure that the gas or plasma flows out from the outlet port 7 correctly. If the rotating container 4 is driven by a motor, the motor can be mounted directly on the bottom of the rotating container 4, and the motor shaft shall be aligned with the rotation axis of the rotating container 4.

During operation, if the fixed inlet pipe T is used to input fluid, it is necessary to ensure that the fixed inlet pipe T will not come into contact with the interior of the rotating container. The outlet port 7 is the ring opening surrounding the fixed inlet pipe T, and is surrounded by the outlet port sleeve 4t extended from the shell of the rotating container 4. It should be noted that in this embodiment, the inlet pipe installation port 3 for placing the inlet pipe and the outlet port 7 are located on the same side of the rotating container 4, so that they can be combined into one combined port.

The purification process includes the input of the liquid into the rotating container 4, which can withhold liquid during high-speed rotation. When the liquid in the rotating container 4 swirls at high speed, substances of higher densities will accumulate at the internal wall, which is farthest away from the rotation axis of the rotating container 4, whereas the substances of lower densities will accumulate at the inner ring region closer to the rotation axis 6.

In order to reduce air drag, the rotating container 4 is preferably of circularly symmetrical shape, such as cylinder or sphere. If air drag and energy efficiency are not of concern, there is no requirement on its appearance. The only requirement is that its center of gravity shall align with the rotation axis 6 before and after water infusion; otherwise, excessive mechanical vibration and noise will be incurred.

In order to more easily display some features of the presently claimed invention, all the embodiments described in this document adopt the cylindrical design. In this exemplary embodiment, the rotation axis 6 is vertical. However, if the input method is not much gravity dependent (input method that make use of siphon principle is gravity dependent), the rotation axis 6 can be set in any direction, including inverted direction where the inlet pipe opening and the outlet pipe opening are located at the bottom.

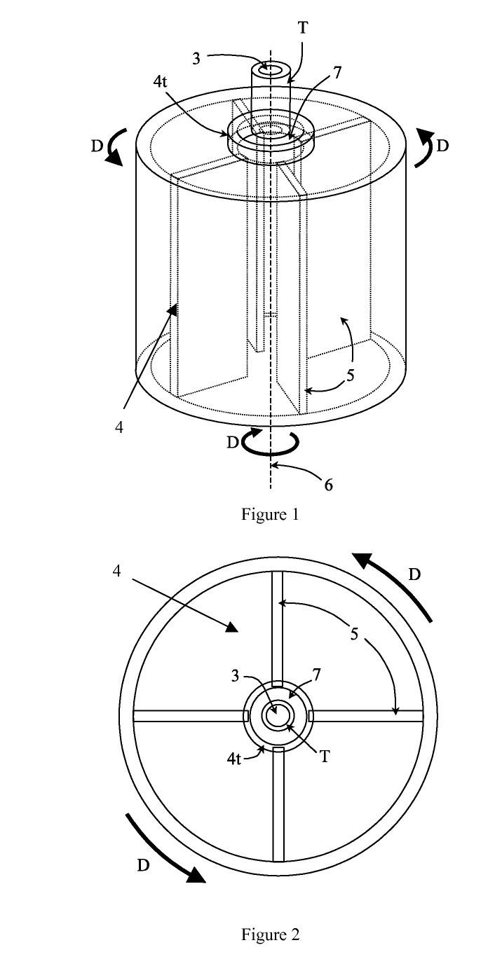

FIG. 2 shows a top view of the rotating container of FIG. 1. In this embodiment, the rotation direction D of the rotating container 4 is counterclockwise. For this example, the effect of clockwise rotation is exactly the same.

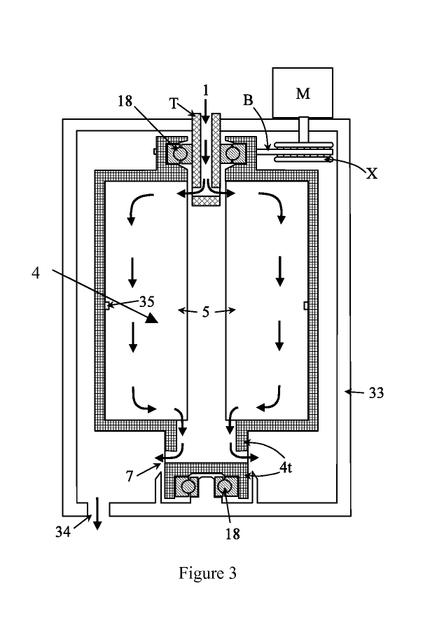

FIG. 3 shows a sectional view of a preferred embodiment of a fluid filtration device (i.e. purifier) of the invention, wherein the inlet pipe installation port (an opening allowing the inlet pipe to pass at the top) and the outlet port 7 are located on the different sides of the rotating container 4 (colored with grid). In this embodiment, the rotating container 4 is located inside the housing 33 of the fluid filtration device, and the fixed inlet pipe T with lateral holes at one end is fixed on the housing 33, so as to infuse the liquid 1 into the rotating container 4. According to the flow direction indicated by the arrow in the figure, the liquid 1 is discharged from the rotating container 4 via the outlet port 7. Finally, the liquid 1 is discharged from the drain outlet 34 of the purifier. In this embodiment, the rotating container 4 is mounted on the housing 33 of the purifier via two bearings 18, and driven by the motor M through synchronous wheel X and synchronous belt B. The bearings 18 at the bottom are not necessarily required, but they can ensure a more solid structure. As the stirring blades 5 are directly connected to the shell of the rotating container 4, heavy impurities through hole 35 are set to achieve more uniform distribution of heavy impurities during operation.

If the stirring blades 5 are planar, the number of the stirring blades is preferably 3-36. Too few blades may easily cause adverse internal turbulence, thus sweeping the gathered heavy impurities and affecting the purification effect. Too many blades 5 will take up too much space, thus reducing the effective storage capacity of the container. To make the best of the interior space of the container, curved blades, particularly spiral blades 5 are more preferable. FIG. 5 shows a top view of the rotating container with 4 spiral stirring blades (With the assistance of some existing computer-aided design software products, it is easy to get the spiral shape, so we will not go further here). Its operation is very similar to the embodiment of the planar stirring blades shown in FIG. 2. However, it is noted that with respect to the spiral pattern of the spiral stirring blades 5 of the rotating container shown in FIG. 5, the counter-clockwise rotation is better than the clockwise rotation. Because during clockwise rotation, the resultant force exerted from the stirring blade will push the heavy impurities gathered on stirring blades 5 moving along the stirring blades 5 and toward the rotation axis. Thus, the gathered heavy impurities will be easily swept by the water flow and get out of the rotating container, resulting in relatively poor purification effect. Of course, if the spiral pattern of the stirring blades 5 is reverse, the rotation direction of the rotating container shall also be changed accordingly. In comparison with flat (planar) stirring blades, the main advantage of spiral stirring blades is that the heavy impurities can gather on the blades at an earlier stage. In other words, the fluid can be purified at an earlier stage after getting into the rotating container 4.

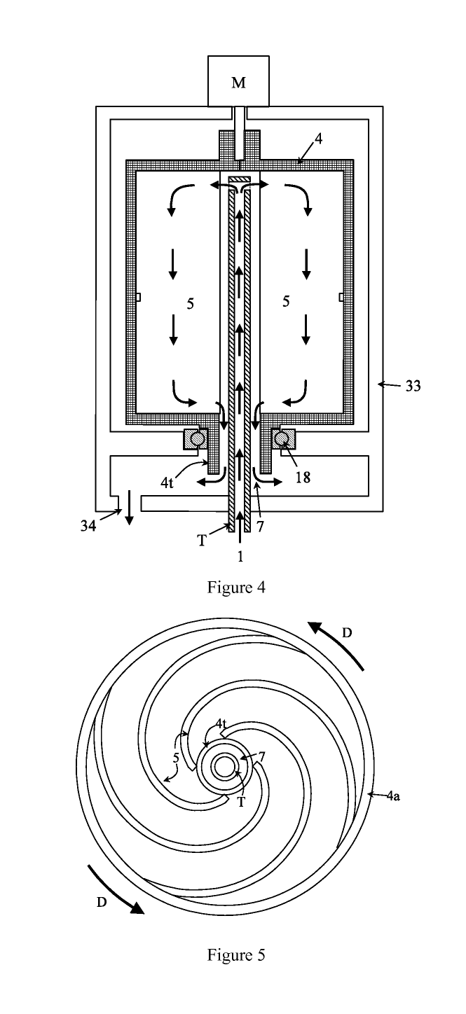

In order to achieve the best cleaning or filtering effect, the fixed inlet pipe T shall be designed according to the structure of the container. In the example shown in FIG. 4, the inlet pipe installation port and the outlet port 7 of the rotating container 4 are located at the bottom. The use of a longer fixed inlet pipe T allows the fluid to be input from the top of the rotating container 4, so that the distance between the input position and the output position of the fluid is greatly increased. In this embodiment, the rotating container 4 is directly connected to the motor M and driven by it. The bearing 18 can reduce the oscillation of the rotating container 4 during its rotation. The purified liquid is discharged from the outlet port 7 of the rotating container 4, and then flows out from the drain outlet 34 of the purifier.

In order to better achieve the filtering purpose of the presently claimed invention, the interior of the rotating container 4 is further improved. The specific internal design is mainly divided into three basic categories, which are distinguished according to three water flow control means:

Category A: No difference between inlet chamber and outlet chamber

Category B: A flow-return partition is used to separate the inlet chamber and outlet chamber

Category C: Similar to the structure of the rotating container described in Category A, but with outlet conducting tube or an outlet passages structure having one end connecting the outlet port 7.

Category A is the simplest structure. The rotating container and purifier shown in FIGS. 1-4 belong to this category. Although it is simple, in certain circumstances, for example, if under space constraints, the rotating container has to be in a small diameter and a long length, category A structure is an appropriate choice.

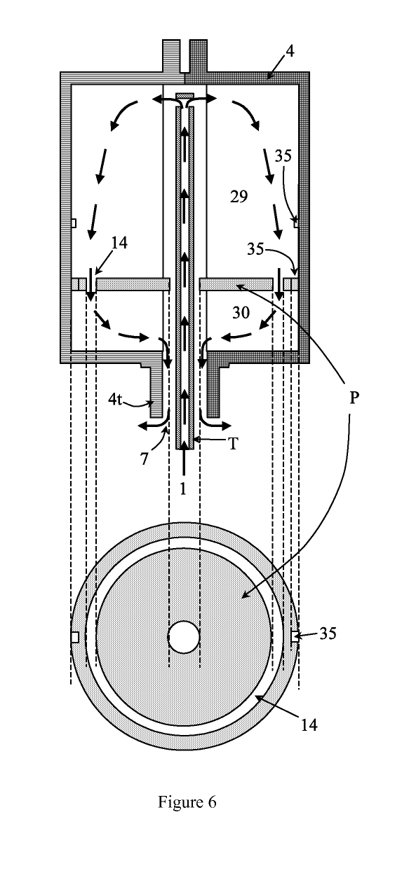

Category B internal design is characterized in that a flow-return partition P is used to separate the container into the inlet chamber 29 and the outlet chamber 30. FIG. 6 shows one embodiment of the Category B rotating container of the presently claimed invention. The rotating container 4 is the same as that of in FIG. 4. FIG. 6 also shows a top view of the flow-return partition P. The liquid 1 enters the inlet chamber 29, then flows into the outlet chamber via the flow-return opening 14 on the flow-return partition P, and finally flows out via the outlet port 7. To ensure that all the fluid reaches the outlet chamber 30 via the flow-return opening 14, the diameter of the hole in the middle of the flow-return partition P shall be small enough in comparison with that of the outlet port 7. The outer ring of the flow-return partition P can prevent the gathered heavy impurities from being washed away by water flow easily, Besides, if it is combined with the shell of the rotating container 4, the physical strength of shell can be reinforced. In this embodiment, the best input position is near the top of the rotating container 4. Moreover, in order to ensure the heavy impurities in the inlet chamber 29 and the outlet chamber 30 distributed more uniformly, a heavy impurities through hole 35 can be implemented on the outermost edge of the flow-return partition P. In general, if the inlet chamber 29 or the outlet chamber 30 is very small, there is no need to implement the stirring blades. The relative sizes of the inlet chamber 29 and the outlet chamber 30 mainly depend on whether the impurities to be filtered out are heavy or light impurities. In the case of heavy impurities, the sizes of the inlet chamber 29 and the outlet chamber 30 are not so critical. In the case of light impurities, a small inlet chamber 29 shall be considered. The main reason is that if the light impurities is first gathered in the inlet chamber 29, and it is difficult to discharge them from the outlet port 7, an embodiment of seawater and oil separation will be described below to further illustrate this point.

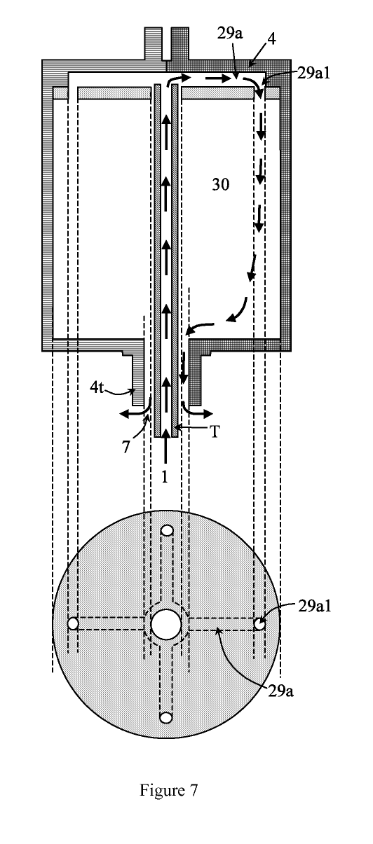

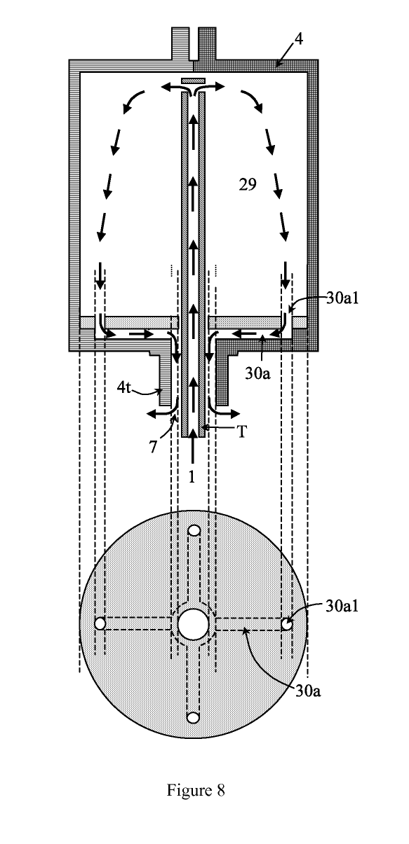

Furthermore, the inlet chamber 29 or the outlet chamber 30 in the embodiment of FIG. 6 can be reduced in size and replaced with pipe or passage structure. This concept is shown in FIGS. 7 and 8. The inlet pipe 29a in FIG. 7 corresponds to the inlet chamber 29 shown in FIG. 6, and the circular flow-return opening 14 in FIG. 6 also evolves into four round holes 29a1 in FIG. 7. The function of the inlet pipe 29a is to draw the fluid to a position near the periphery of the rotating container. The outlet pipe 30a in FIG. 8 corresponds to the outlet chamber 30 shown in FIG. 6, whereas the circular flow-return opening 14 in FIG. 6 also evolves into four round holes 30a1 in FIG. 8. The function of the outlet pipe 30a is to draw the fluid from a position near the periphery of the rotating container to the outlet port 7 close to the rotation axis. In some of the following embodiments, the flow-return openings 14 are some small holes, and the design that replaces the inlet chamber or the outlet chamber with pipe or passage structure is very suitable.

The interior of Category C rotating container is mainly characterized in that the structure is equivalent to adding outlet conducting tubes or outlet passages structure in Category A rotating container. The opening at one end of the outlet pipe or the outlet passage structure is located in a position near the periphery of the rotating container. Its function is equivalent to that of the flow-return opening 14 of the Category B design, while the other end is connected to the outlet port of the rotating container.

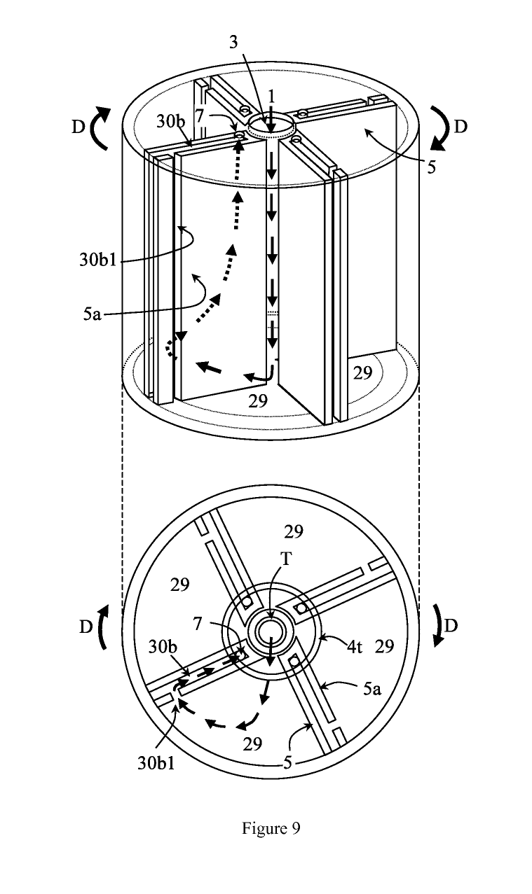

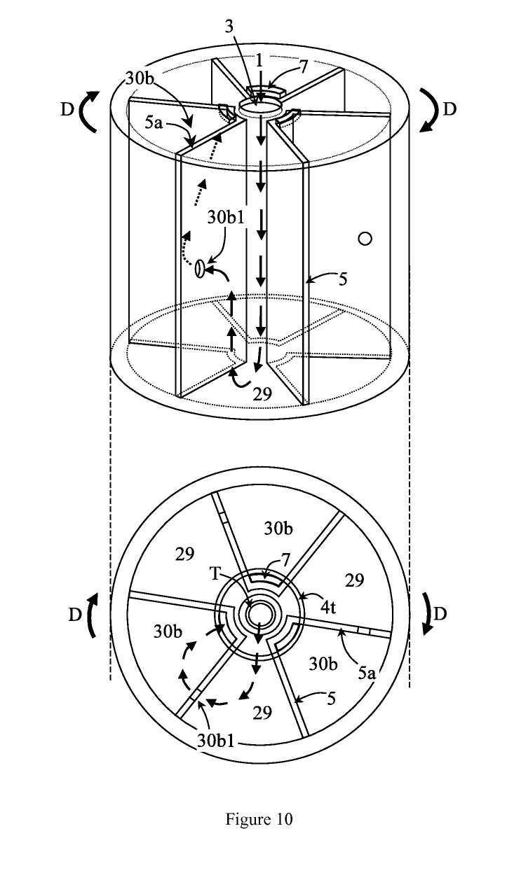

FIG. 9 shows an elevation view and a top view of an embodiment of a Category C rotating container. In this embodiment, the rotating container has four stirring blades 5. Moreover, when collaborated with the stirring blade 5, the spacer 5a (which has an opening 30b1 and whose size is almost equal to the size of the stirring blade 5) is used to form an outlet passage structure 30b. The opening 30b1 at one end of the outlet passage structure 30b locates near the periphery of the rotating container, whereas the other end is connected to outlet port 7, which is a hole in this case. According to the flow path shown by the arrow, the liquid 1 is infused into the inlet chamber 29, then flows into the outlet passage structure 30b via the opening 30b1, and flows out via the outlet port 7 at the top of the rotating container. The top view in FIG. 9 shows the position of the fixed inlet pipe T and the outlet port sleeve 4t. In order to more clearly show the internal structure of the embodiment of the rotating container, the fixed inlet pipe T and the outlet port sleeve 4t are not indicated in the elevation view in FIG. 9. This approach also applies to the elevation views in FIGS. 10 and 11.

FIG. 10 shows an elevation view and a sectional view of another embodiment of the rotating container of the invention. The rotating container in this embodiment also belongs to Category C internal design. In this embodiment, the outlet passage structure 30b is comprised of the common stirring blade 5 and the spacer 5a with a hole-like opening 30b1. The hole-like opening is very small relative to the spacer 5a, and the size and shape of the spacer 5a are similar to that of the stirring blade 5, so the spacer 5a is used as the stirring blade. As a result, the outlet passage structure 30b is designed to be about the same size as the inlet chamber 29. The flow pattern of the liquid 1 in this embodiment is basically similar to that of the liquid 1 in the embodiment shown in FIG. 9, so we will not go further here.

Through replacing the outlet passage structure 30b in the rotating container shown in FIG. 9 with an outlet pipe 30a, another embodiment of Category C internal design can be obtained, as shown in FIG. 11. Its principle is very similar to that of the embodiments in FIGS. 9 and 10. However, among the three Category C internal designs, the rotation direction D shown in FIG. 9 is the most restricted one. Heavy impurities will gather on the stirring blades and slide to the periphery due to the rotation of the stirring blades; however, if the clockwise rotation shown in FIG. 9 is changed into counterclockwise rotation, lots of heavy impurities will gather on the spacer 5a, and slide to the periphery. When reaching the opening 30b1, the heavy impurities will be swept away by water flow and finally discharged from the outlet port 7. Therefore, corresponding to the design of the stirring blade 5, the clockwise rotation D shown in FIG. 9 is better.

In theory, the water flow control methods of Category B and Category C can be combined for implementation. However, in practice, the effect is not much better than the water flow control method of Category B or Category C alone.

Filter material can be used to increase the purification function.

Where appropriate, filter core or filter membrane can be used to effectively increase the filtering capacity. Moreover, under the action of centrifugal force, the filter clogging will be improved.

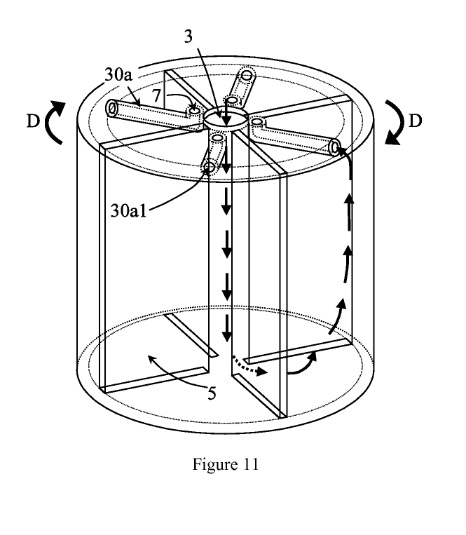

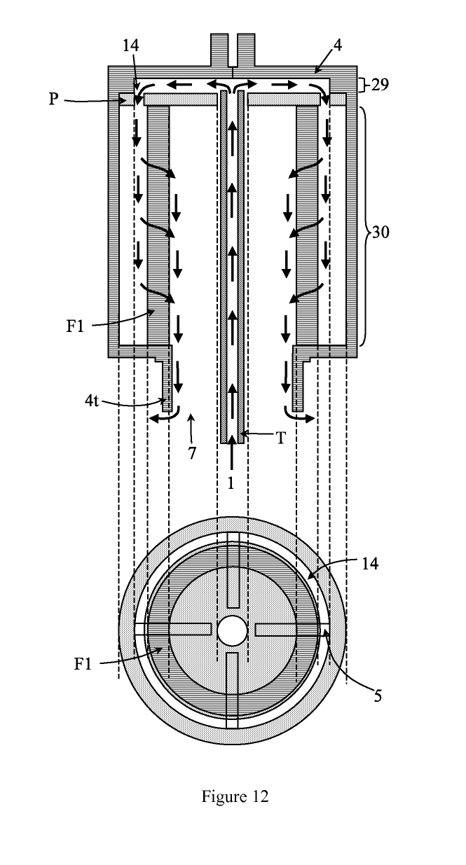

FIG. 12 shows an embodiment of the Category B rotating container with a ceramic filter core F1. A higher pressure is required to pass the fluid through the filter core. Therefore, the maximum axial distance of the outlet port is much bigger than that of the inlet pipe installation port (in comparison with the design where filter core is not used). The calculation of the required difference between them belongs to known physics knowledge, so we will not go further here. FIG. 12 also shows the relative positions of the flow-return partition P, ceramic filter core F1 and the stirring blade 5 located in the inlet chamber 29 (Note that the stirring blades 5 are not indicated in the upper figure). The ceramic filter core F1 is set in the inlet chamber 29, and its diameter is slightly smaller than that of the flow-return opening 14. A better design is the ceramic filter core plus the stirring blades (which are not indicated in the figure), so as to enable better synchronous rotation of water in the outlet chamber 30.

In addition to the ceramic filter core F1, almost all existing filter materials are also applicable. If a filter core made of reverse osmosis membrane is used, it is also applicable to seawater desalination. In the last part of this document, there is a description about relevant embodiments.

Category B internal design is most suitable for employing a filter core. In addition to the embodiment of FIG. 12, it is also possible to use disc-shaped filter material to replace the flow-return partition P of the Category B interior design. The disc-shaped filter material has a center hole for placing the inlet pipe, but is not necessary to have flow-return opening 14. And also, the outer edge of the flow-return partition shall not be attached to the shell of the rotating container. However, from the viewpoint of clogging prevention based on the centrifugal force, this design is worse than the embodiment of FIG. 12.

Category C internal design is also suitable for using filter material. Its design principle is basically similar to that of Category B, that is, water is filtered with filter material before being discharged from the outlet port. For example, in the embodiments of FIGS. 9 and 10, the spacer 5a can be replaced with a piece of filter material without an opening 30b1. In the embodiment of FIG. 11, the filter material can be put into the outlet pipe 30a1. Of course, in order to get enough water pressure to pass the fluid through the filter material, the previously described approach shall also be used to move the outlet port 7 to a position further away from the rotation axis, so that the maximum axial distance of the outlet port is considerably larger than the maximum axial distance of the inlet pipe installation port. Furthermore, if the purpose of the physical filtration is not of concern and focus is only put on the purpose of biological filtration, in addition to the design in which a filter core is installed in the outlet chamber 30, the filter core can also be installed in the inlet chamber 29 or the space between the stirring blades 5 and/or between the spacers 5a. However, the selected filter core shall be very hydrophobic, so as to avoid clogging.

Considerations and Advantages of Multiple Chambers in Parallel (Connection) or in Series (Connection)

If the Category A, B and C rotating containers are connected in series or in parallel, the purification effect can be further strengthened; however, the manufacturing cost will be much higher. Therefore, the presently claimed invention also includes combining multiple basic chamber structures of the rotating containers in series or in parallel inside the shell of one rotating container, so as to obtain a better purification effect.

The specific implementation method is that: one or more of the three basic types of chamber structures are connected together to form a multi-chamber structure. In the case of parallel connection, the outlet chambers 30 or the outlet pipes 30a or the outlet passage structures 30b will be interconnected, and the fluid in them will be drawn to the position near the edge of the outlet port 7 or the combined port of the rotating container, whereas the fluid will be distributed to the inlet chambers 29 or the inlet pipes 29a or the inlet passage structures 29b via the fixed inlet pipe. In the case of series connection, except that the fluid in the outlet chamber or the outlet pipe or the outlet passage structure closest to the outlet port is directly discharged through the outlet port, the fluid in other outlet chambers or the outlet pipes or the outlet passage structures will be drawn to the adjacent inlet chamber 29 or the inlet pipe 29a or the inlet passage structure 29b.

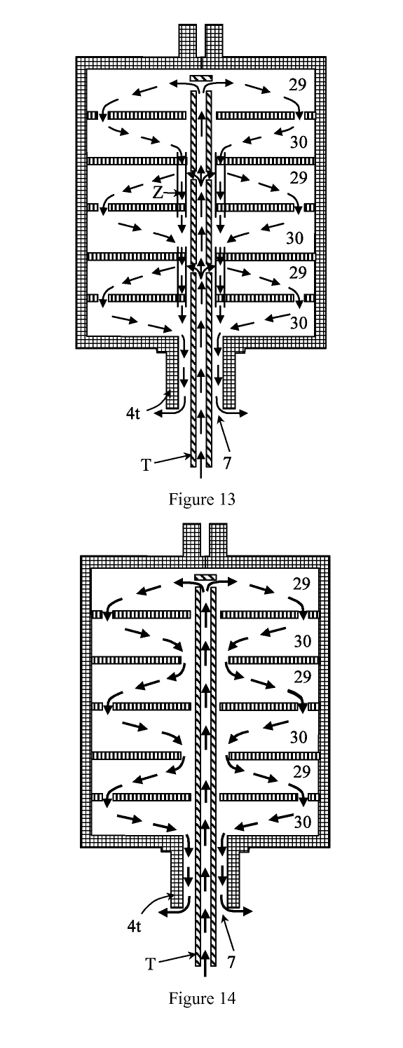

FIG. 13 and FIG. 14 show a parallel multi-chamber rotating container and a serial multi-chamber rotating container respectively. FIG. 13 shows the parallel chambers of a Category B rotating container. There are three inlet chambers 29 and three outlet chambers 30. A multi-hole fixed inlet pipe T is used to distribute liquid to different inlet chambers 29. With respect to liquid output, except that the liquid in the outlet chamber 30 closest to the outlet port 7 is directly discharged through the outlet port 7 of the rotating container, fluid in all other outlet chambers 30 is interconnected and finally drawn to the outlet port 7 of the rotating container via the pipe Z.

The series connection structure of Category B rotating container is less complex than the parallel connection structure. As shown in FIG. 14, it is a multi-chamber rotating container with three Category B chambers connected in series. There are three inlet chambers 29 and three outlet chambers. Except that the fluid in the outlet chamber 30 closest to the outlet port 7 is directly discharged through the outlet port 7, the fluid from the other two outlet chambers 30 directly flows to the next inlet chamber 29.

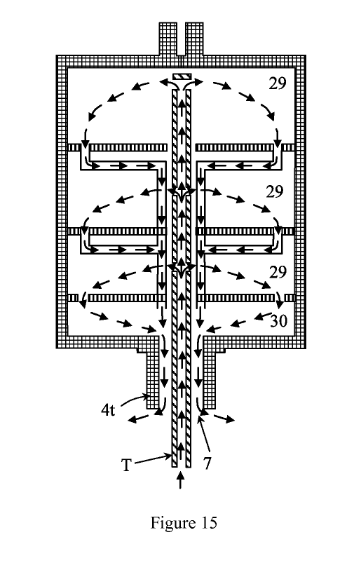

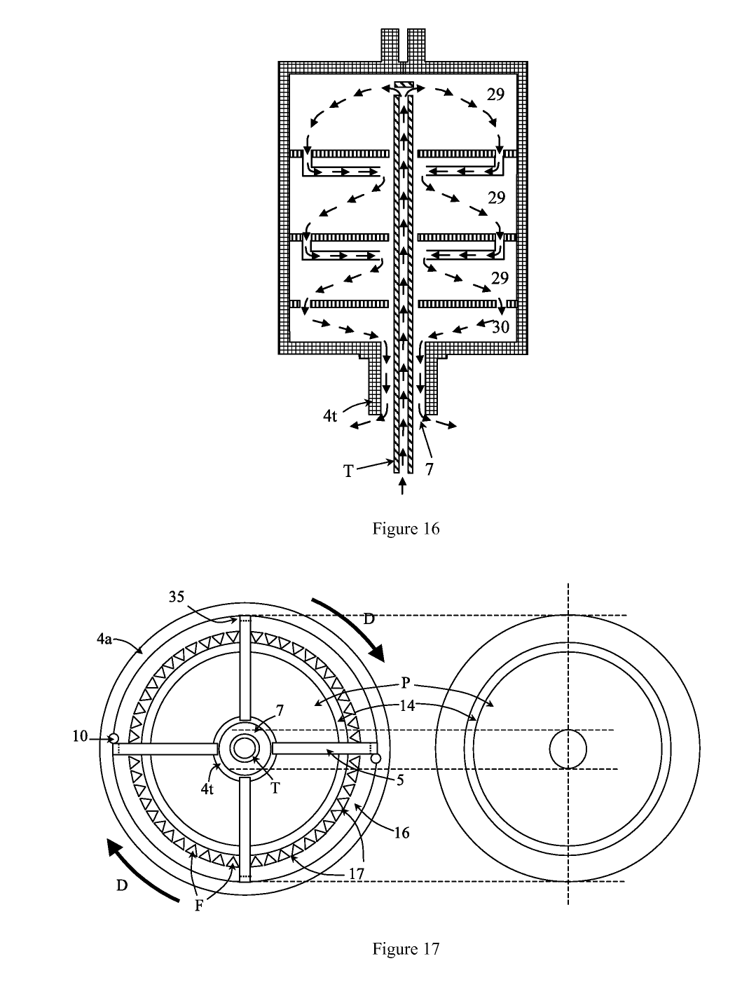

In the embodiments of FIGS. 15 and 16, the two outlet chambers 30 in FIGS. 13 and 14 are replaced with pipes.

With respect to the parallel connection method of Category C rotating container, as its outlet ports are small holes, the parallel connection method of Category B rotating container is more suitable, that is, a pipe is used to draw the liquid in the related outlet chambers 30 or the outlet pipes 30a or the outlet passage structures 30b to the main outlet port 7 of the rotating container. With respect to the series connection method of Category C rotating container, the paraxial outlet ports of the related outlet chambers 30 or the outlet pipes 30a or the outlet passage structures 30b are aligned with the input chambers 29 below (assuming the main outlet port 7 of the rotating container is located at the bottom).

The principle of Category A parallel and serial multi-chamber design is very similar to that of Category B, so we will not go further here.

The multi-chamber design principle that integrates Categories A and C or integrates Categories A, B and C is also very similar to the Category B or Category C multi-chamber design principle, so we will not go further here.

In comparison with the single-chamber rotating container of the same volume, the parallel or serial multi-chamber rotating container has better purification effect and does not deform easily. These advantages are especially obvious at the time of high-speed rotation. In other words, multi-chamber design can adapt to the application of high-speed rotation.

Impurity Storage Space

In order to prevent the gathered heavy impurities (not shown) from being rolled up and swept away by the nearby water flow due to excessive accumulation, an optimum design is to add an impurity storage space on the outermost periphery. FIG. 17 shows a sectional view of an embodiment of a Category B rotating container according to this invention. In the figure, the structure composes of triangles, which can be understood as a baffle plate F covered with many V-shaped grooves or tapered holes. The baffle plate F has the same height as the stirring blade 5, that is, it stretches from one end of the cylindrical container to the flow-return partition P. An impurity storage space 16 is formed between the baffle plate F and the shell. The flow direction of the fluid in this Category B rotating container is similar to that in the embodiment shown in FIG. 6. The heavy impurities (not shown) are discharged into the impurity storage space 16 via the impurity outlet 17. In such designs, the impurity outlet 17 shall be small enough, but also allows heavy impurities to pass through. Its design principle is: the total area of the impurity outlet 17 shall be much smaller than the total area of the flow-return opening 14 (it refers to Category B internal design) or the opening 30b1 of the outlet passage structure 30b near the periphery (it refers to Category C internal design), so as to prevent a large amount of liquid from flowing through the impurity storage space 16 and rolling up the gathered heavy impurities. However, considering the manufacturing difficulty and application needs, the general size of 0.1-3 mm is very appropriate. If the rotating container has no drain hole 10, larger impurity outlet 17 will facilitate the removal of the heavy impurities in the impurity storage space. With respect to the shape, preferably the size of the impurity outlet 17 shall gradually become narrower toward the impurity storage space 16, that is, the side near the rotation axis 6 is big, and the side near the impurity storage space 16 is small. For example, a tapered hole or a V-shaped groove is also very suitable. Via this type of convergent hole, heavy impurities can enter the impurity storage space 16 easily, but hard to escape. Because of centrifugal force, the slope formed by the tapered hole or V-shaped groove can prevent heavy impurities from condensing on it.

For easy removal of the heavy impurities from the impurity storage space 16, some drain holes 10, which can be opened and closed, shall be implemented on the rotating container. In addition, as shown in FIG. 17, if the outermost end of the stirring blade 5 attaches to the shell 4a of the rotating container, the physical strength of the rotating container can be enhanced, but the better choice is to add some heavy impurities through holes 35 on the outermost edge of the stirring blade 5, so that the heavy impurities gathered in different chambers can be uniformly distributed among the chambers and discharged through the drain hole 10. In this embodiment, the drain hole 10 is set on the round cover at one end of the cylindrical rotating container.

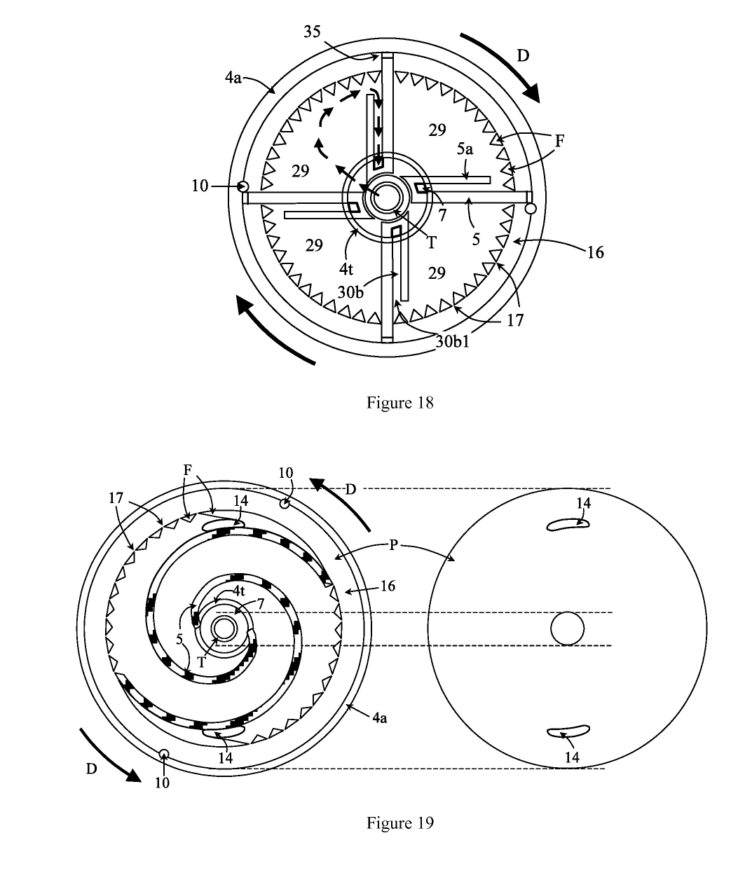

FIG. 18 shows a top view of the rotating container according to another preferred embodiment. In comparison with the embodiment of FIG. 9, this embodiment has an impurity storage space 16. Similar to the embodiment of FIG. 17, the baffle plate F in FIG. 18 can be understood as a curved face covered with many V-shaped grooves or tapered holes. The baffle plate F has the same height as the stirring blade 5, that is, it stretches from one end of the cylindrical container to the other end. The fluid is drawn into the inlet chamber 29 through the central inlet pipe T, then reaches the outlet passage structure 30b via the opening 30b1 formed by the spacer 5a, and is discharged from the outlet port 7.

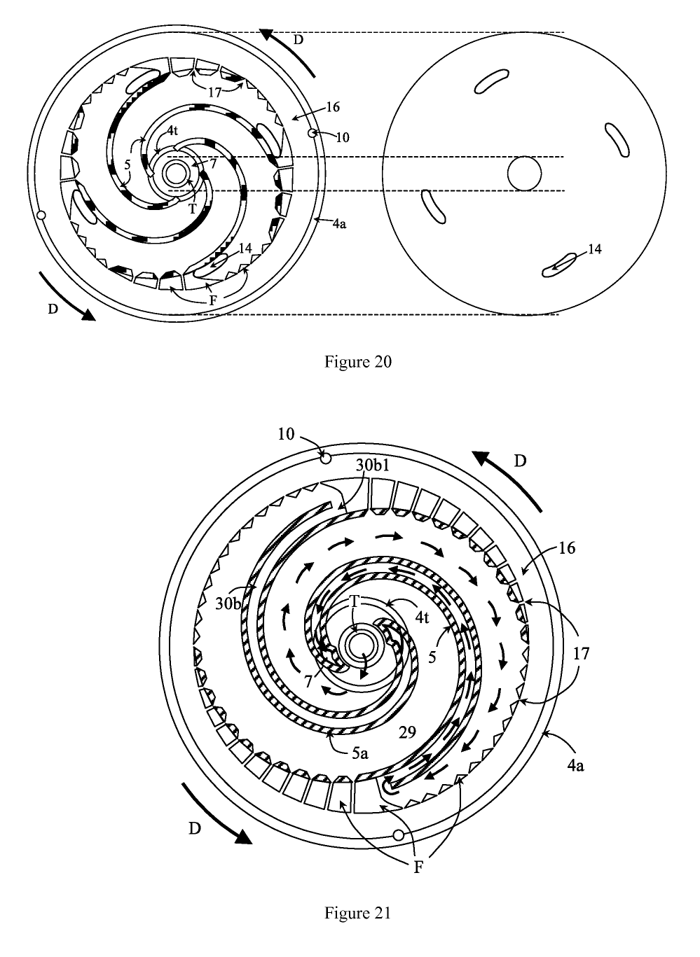

An important part of the presently claimed invention is the rotating container with spiral stirring blades. The method, which uses an impurity storage space to prevent gathered heavy impurities from being swept away by water flow, is particularly suitable for the rotating container with spiral stirring blades. FIG. 19 shows a rotating container with 2 spiral stirring blades. This embodiment also belongs to the Category B internal design. As the spiral stirring blade can allow heavy impurities to gather on it and slide to the outermost end along its surface, the power of heavy impurities collection is greatly increased. Like the two embodiments, the baffle plate F in the embodiment of FIG. 19 is generally circular. Two sections of the baffle plate have tapered holes or V-shaped grooves (represented by the triangles in the figure), and the other two sections near the flow-return opening 14 have no tapered holes or V-shaped grooves. This arrangement mainly prevents the heavy impurities gathered in the impurity storage space 16 from being rolled up and swept away by the strong water flow near the flow-return opening 14. Impurity outlet 17 not only can be implemented on the baffle plate. But can also on the outer end of the spiral stirring blade. The embodiment of FIG. 20 illustrates this concept.

In FIG. 20, there are a total of four stirring blades 5 (colored with slash). Tapered holes or V-shaped grooves are set at the outer end of the stirring blades 5, and connect with some passageways on the baffle plate which lead to the impurity storage space 16, so that the heavy impurities in this position of blade 5 can be discharged into the impurity storage space 16. This arrangement can prevent excessive accumulation of heavy impurities at the end region of the stirring blades 5, so that the gathered heavy impurities will not be easily swept away by water flow. The location of the Tapered holes or V-shaped implemented on the stirring blade depends on the location where the heavy impurities start gathering. Of course, the baffle plate F has the same height as the stirring blade 5.

FIG. 21 shows another design in which impurity outlets 17 are set on both the outer end of the stirring blades 5 and the baffle plate F. It is a Category C rotating container with two spiral stirring blades 5 and two baffle plates 5a. The design considerations for impurity outlet 17 are basically the same as that in FIG. 20. In addition, similar to the embodiments of FIGS. 19 and 20, it is recommended not to implement impurity outlets on the baffle plate F near the opening 30b1 of the outlet passage structure 30b close to the periphery in FIG. 21.

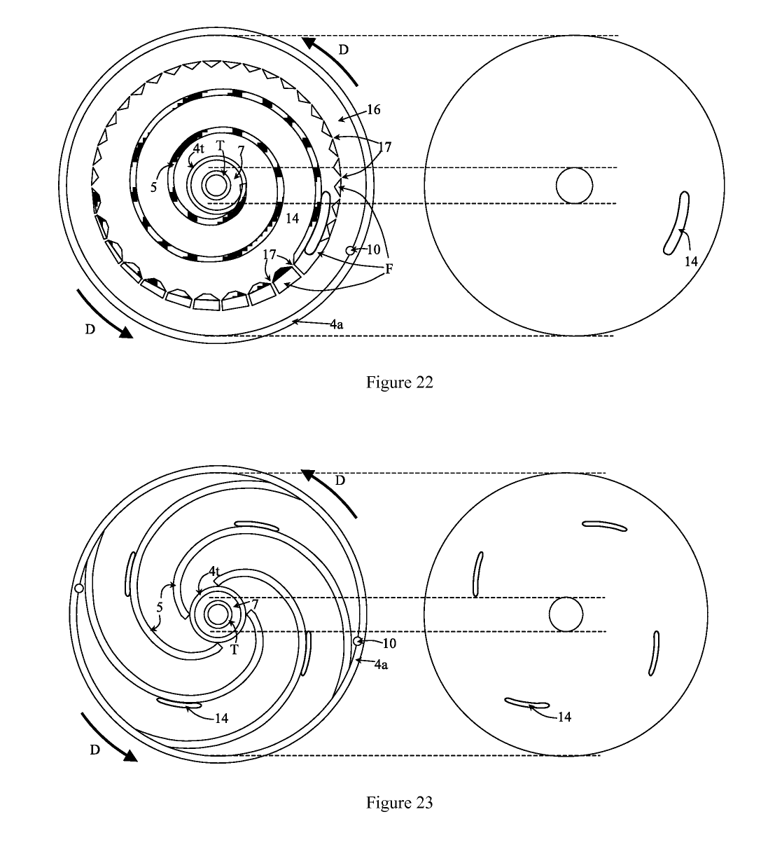

The internal designs are relatively symmetrical. In fact, symmetry is not an inevitable feature of the presently claimed invention. FIG. 22 shows a rotating container whose interior is not symmetric. It is similar to the designs in FIGS. 19 and 20, but this design has only one spiral stirring blade 5. With the assistance of some existing computer-aided design software products, the center of gravity can be adjusted to align with the rotation axis 6, or it can be corrected after production and actual test. The most important thing is to ensure that its center of gravity is aligned with the rotation axis 6 regardless fluid 1 is infused or not. The methods to correct the center of gravity are the commonly used techniques for some existing electrical products with high-speed rotational structures, so we will not go further here.

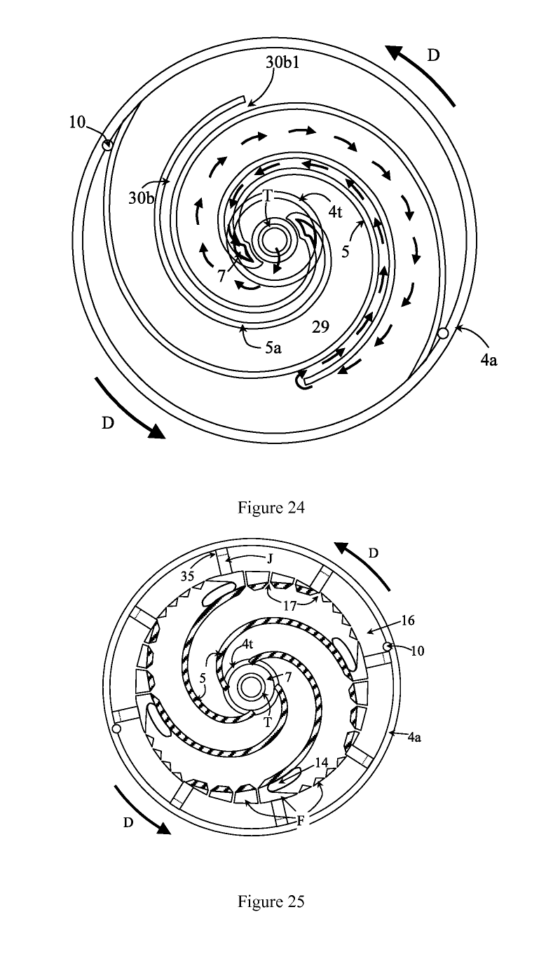

In the embodiments of the rotating containers with spiral stirring blades in FIGS. 19-22, an impurity storage space 16 is included. To achieve an embodiment of a rotating container without impurity storage space, please refer to the embodiments in FIGS. 23 and 24. FIG. 23 shows a top view of a Category B rotating container with four spiral stirring blades 5. In this embodiment, the flow-return opening is narrower, and the main reason for this design is to keep a suitable distance away from the high impurities gathered on the opposite stirring blades 5, so as to prevent the heavy impurities from being swept away by water flow during operation. FIG. 24 shows a top view of a Category C rotating container. Its operating principle and structure are relatively similar to the embodiment of FIG. 21.

The design of spiral stirring blade 5 has better purification performance, but from the viewpoint of manufacturing, it has higher technical requirements in comparison with planar stirring blade.

Means and Methods to Strengthen the Structure of Rotating Container

To strengthen the structure of the rotating container 4 to meet the needs of high-speed rotation, in addition to the multi-chamber design, another effective method is to make the stirring blade 5 and the flow-return partition P (only applicable to Category B rotating container 4) to directly attach to the shell of the rotating container 4. However, this method is not applicable to design in which the shell can be detached for easy cleaning. In addition, it is also a feasible means to add some axial reinforcement bars inside or outside of the shell of the rotating container 4 or add ring-shaped reinforcement material along the circumference of the shell. However, if reinforcement material is used on the inner wall of the shell, heavy impurities may be separated by the reinforcement material during operation, resulting in uneven distribution of heavy impurities. The solution is to implement heavy impurities through holes 35 on the flow-return partition P or stirring blade 5, which has been described above. FIG. 25 shows an embodiment of a rotating container, wherein inner wall of the shell is added with axial reinforcement bars J. Like the embodiment shown in FIG. 20, it is a rotating container with 4 spiral stirring blades. In this embodiment, the axial reinforcement bars J connect the shell with the internal structure, so that the structure of the rotating container 4 is further strengthened. Heavy impurities through holes 35 are set on the axial reinforcement bars J.

Location and Quantity of Drain Holes

The drain hole 10 is used to facilitate the discharge of heavy impurities gathered near the periphery of the rotating container 4, and the general discharge method is to open the drain hole 10 and rotate the rotating container 4 at high speed. In the design in which an impurity storage space 16 is included, during the discharge process, water in the container or the cleaning solution specifically infused into the container for cleaning purpose will be drawn into the impurity storage space 16 via the impurity outlet 17, and the discharged from the drain hole 10. Therefore, the heavy impurities gathered near the impurity outlet 17 can be easily washed off. However, the heavy impurities near the baffle plate 17 without impurity outlet can hardly be washed off. To set a drain hole 10 in a position opposite to the baffle plate F without impurity outlet 17 is a method to improve the situation. The reason is that the rapid water flow near the drain hole 10 can help cleaning away the heavy impurities gathered nearby during discharge.

In the design in which no impurity storage space 16 is included, the drain hole 10 should be set in the position shown in FIGS. 23 and 24. This is the most likely that the inner wall of the shell can be washed by water flow during cleaning. However, in the embodiment of FIG. 23, there are four stirring blades 5, which form four inlet chambers 29 or outlet chambers 30 (depending on whether the top view represents the inlet chambers 29 or the outlet chambers 30), but there are only two drain holes 10. The way of improvement is to set some heavy impurities through holes 35 at the end of the stirring blades 5.

There can be only one drain hole 10. However, two or more drain holes make it easier for the center of gravity of the rotating container 4 to align with the rotation axis. However, the design of only one drain hole 10 also has its advantages, that is, the maintenance and operation costs are relatively low. In the design of only one drain hole 10, it must be ensured that all spaces, which can store heavy impurities, are interconnected and the impurities can be discharged from the same drain hole 10. One method is to add at least one heavy impurities through hole 35 on the edge of the stirring blade 5 connecting the shell, so as to allow the heavy impurities to pass through. In addition, if Category B interior design is adopted, it is also recommended to set heavy impurities through holes 35 on the outermost edge of the flow-return partition P.

Of course, even in the design of more than one drain hole 10, a better choice is to interconnect all spaces, which can store impurities. The reason is that it can be ensured that the center of gravity of the rotating container 4 can be aligned with the rotation axis during the discharge operation of the rotating container 4 or during its operation without any discharge.

Non-Circularly Symmetric Inner Wall

To facilitate the discharge of the heavy impurities gathered on the inner wall of the shell 4a through the drain holes 10, a good selection of the positions of the drain holes 10 is important. In addition, one can employ a rotating container 4 with a non-circular symmetry shell's inner wall such as an elliptical one and set the two drain holes 10 at the two positions furthest away from the center of the ellipse. Due to the centrifugal force, the heavy impurities will first gather in these two positions during high-speed rotation.

Designs Obtained from the Following Three Methods to Collect or Remove Heavy Impurities in Rotating Container

I. Kept in rotating container without cleaning

II. Manual cleaning

III. Automatic cleaning

The first method is relatively suitable for some very extreme situations, for example, the heavy impurities are highly radioactive substances that is not recommended to clean away without specialized knowledge.

The second method is manual cleaning of the rotating container 4. In addition to infusing cleaning solution into the rotating container and rotating the rotating container clockwise and counter-clockwise alternately to achieve the cleaning purpose, an aforementioned drain hole 10, which can be opened/closed, will be very useful. To implement this, a simple method is to make the drain hole 10 as a tapped hole so that it can be plugged by a screw. Another possible method is to use a quick clamp structure, which can be easily found in a large hardware store. The positions of the drain holes 10 are indicated in the embodiments of FIGS. 17-25. When the drain holes 10 are opened and the rotating container 4 rotates at high speed, the heavy impurities in the container will come out. If necessary, cleaning solution or water can be infused via a fixed inlet pipe T to help cleaning.

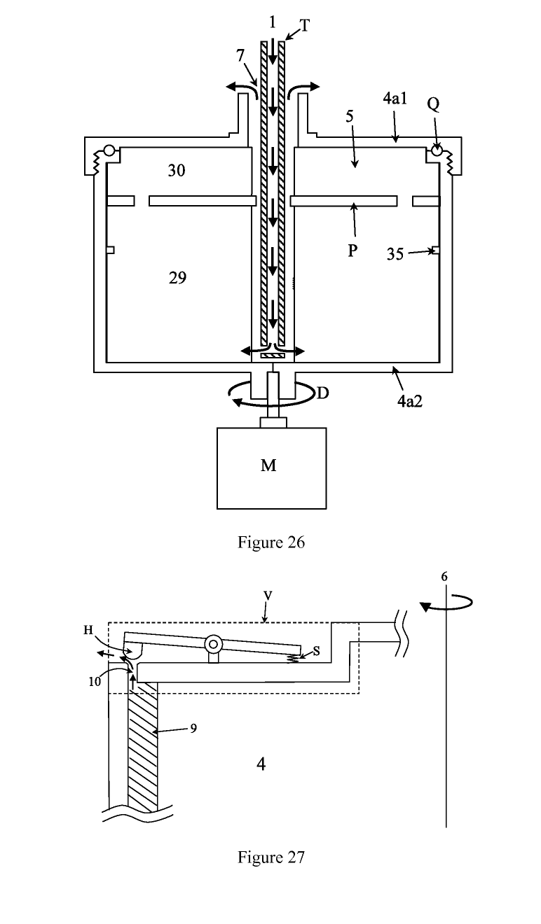

Another design for easy cleaning is a detachable shell. FIG. 26 shows an embodiment of a rotating container whose shell can be detached for cleaning. In this case, the rotation direction D of the rotating container under normal operation is clockwise (top-view), and the drive motor is directly connected to the lower half 4a2 of the shell and drives the rotation of the shell directly, and the upper half 4a1 of the shell of the rotating container 4 shall be designed to screw on the lower half 4a2 of the shell in counterclockwise direction, otherwise, it will come loose during operation. The O-ring made of rubber is used to prevent leakage.

The third method can be implemented by three control means, which are rotational speed control, solenoid control and water pressure control. Each of the three control means includes at least one flexible valve V. The difference is that the flexible valve V is opened in different ways to discharge impurities. For the rotational speed control means, rotational speed control is used to control the flexible valve V to discharge the heavy impurities in the rotating container. FIG. 27 shows an embodiment of a flexible valve V having a spring S. In this embodiment, the rotation axis of the rotating container 4 is on the right side of the figure (the other half is omitted), and the drain hole 10 is located near the rim of the round cover at the top of the rotating container 4. The structure of the flexible valve V is of lever type. The power provided by the spring S can close the valve. In this embodiment, through the high-speed rotation of the rotating container 4, the pressure of the liquid in the drain hole 10 is increased to push and open the flexible valve V, so that the heavy impurities 9 stored in the container 4 can be discharged. To ensure that the valve can be tightly closed whenever necessary, the pressure head H shall be made of elastic materials preferably, such as rubber. In addition, if the lever is made of flexible materials such as graphite (carbon fiber), a hard pad can be use to replace the spring S so that the graphite lever bends and produces the required pressure to press down the sealing head H.

Although the best position of the drain hole 10 is located furthest away from the rotation axis of the rotating container 4, this arrangement needs a high-strength spring (especially when applied in liquid) to properly seal the drain hole whenever necessary. In addition, in some cases, if a heavy impurity collection container of a small diameter is set under the rotating container 4, the purpose can be easily achieved by setting the drain hole 10 in a position near the rotation axis.

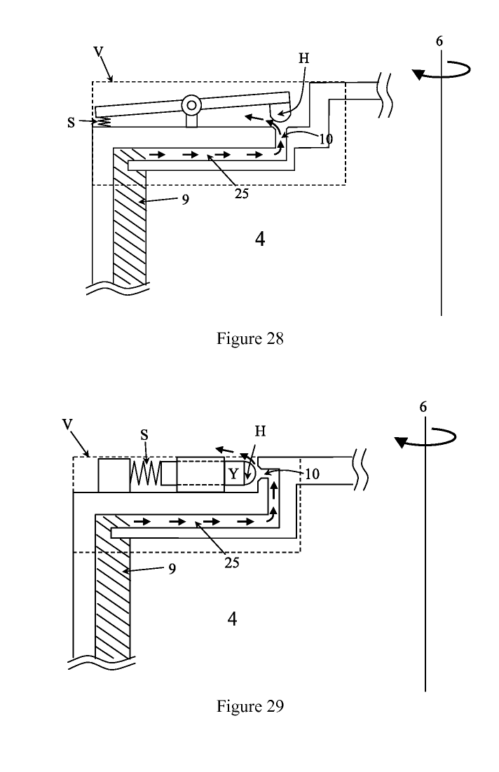

With respect to the above problem, FIG. 28 provides a solution. FIG. 28 shows an embodiment of another flexible valve V. Similar to the embodiment shown in FIG. 27, the rotation axis is on the right side. A drain tube 25 is used to transfer the drain hole 10 from a position furthest away from the rotation axis (on the left side) to a position near the rotation axis (on the right side). If the distance away from the rotation axis is shorter, a smaller pressure is required for liquid discharge. In other words, the valve can be closed with a smaller force. Therefore, in comparison with the embodiment of FIG. 27, the spring with lower strength in FIG. 28 can also shut off the drain hole 10.

FIG. 29 shows an embodiment of another flexible valve V. In this embodiment, a drain pipe 25 is used to transfer the drain hole 10 from a position furthest away from the rotation axis (on the left side) to a position near the rotation axis (on the right side). The flexible valve V is set in the form of piston. When the rotating container rotates at high speed, the centrifugal force of the piston Y plus the fluid pressure on the drain hole 10 pushes and opens the valve (piston).

Each flexible valve V in FIGS. 27-29 is set near the rim of the round cover at one end of the rotating container 4. As its structure is very simple, it can be understood that it can also be set on the cylindrical surface of the rotating container 4. It should be noted that if the piston structure of FIG. 29 is set on the cylindrical surface of the rotating container 4, that is, it is turned by 90 degrees (i.e. the piston Y parallel to the rotation axis 6), the switching characteristics of the piston will change. In other words, the centrifugal force of the piston Y plays little role in opening/closing this flexible valve V.

The switching design of the speed control valve has very high application value. To obtain heavier substances in liquid, high-speed rotation can be used to discharge such substances from the drain hole 10. To obtain lighter substances in liquid, speed is maintained at a rate such that the speed control valve remains closed and liquid is infused continuously, enabling the lighter substances to be discharged from the outlet port 7.

In addition to the flexible valve, the valve can also be opened by electromagnetic means. The method is: in the embodiment shown in FIG. 27 or FIG. 28, attach a magnet at the end of the lever near the position of the spring S, and then add a coil around the rotating container at the same height level of the magnet. The coil is fixed and does not touch the rotating container. To open the valve, power the coil to generate a magnetic force against the force exerted by the spring S.

The third mode of valve opening is only applicable to the rotating container whose maximum axial distance of the outlet port is considerably different from the maximum axial distance of the inletport. During conventional purification operation, the inlet chamber is not fully replenished (that is, the water level does not reach the position of the maximum axial distance of the inlet port), assuming that the water pressure near the drain hole 10 cannot make the flexible valve open. If the speed of water input is suddenly increased so that it is sufficient to make the water level in the inlet chamber closer to the rotation axis, the water pressure near the drain hole 10 will increase. At this time, the drain hole will open.

In order to achieve a fully automatic discharge, the water pressure control mode requires the control of water input and the use of optical sensor to detect the gathering of heavy impurities. However, in some special cases where a filter core is set, through filter core clogging, the inlet chamber can retain more water. such that the water level is closer to the rotation axis. This will increase the water pressure to open the drain hole 10 of the flexible valve V, and it should be noted that this method can achieve automatic discharge without the need to change the rotational speed or the water input speed.

Synchronous Inlet Pipe

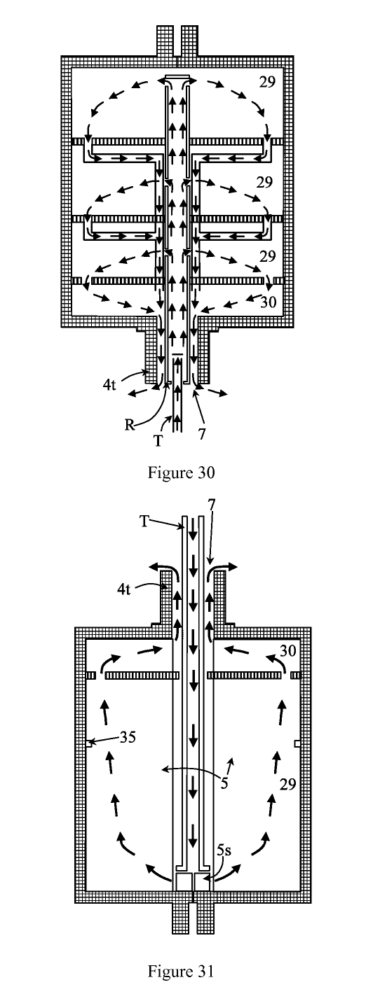

The rotating container 4 of the presently claimed invention generally uses a fixed inlet pipe for water input, and the inlet pipe is fixed on the housing of the purifier. However, in some cases, such as the parallel multi-chamber rotating container uses a multi-hole pipe as the fixed inlet pipe to distribute liquid to different inlet chambers, it is difficult to stably maintain the water input rate for each inlet chamber especially running for a long time. The reason is that the inlet water flow is generally not too fast, so that the water outlet holes of the multi-hole pipe can be easily clogged by pollutants. The solution is to set a synchronous inlet pipe R near the rotation axis of the rotating container 4. The synchronous inlet pipe R rotates with the rotating container 4 synchronously. Due to the centrifugal force, the holes of the synchronous inlet pipe R will not be clogged essentially. The embodiment of FIG. 30 shows this design. Basically, the embodiment of FIG. 30 is very similar to the embodiment of FIG. 15. In FIG. 30, a synchronous inlet pipe R is set in the position of the rotation axis of the rotating container. There is a round disc with central hole covering the inlet of the synchronous inlet pipe R, and hence the infused liquid will not flow out from the inlet during high-speed rotation. It should be noted that the rotating container with a synchronous inlet pipe R also needs a fixed inlet pipe T for liquid input. However, this fixed inlet pipe T is not necessarily a multi-hole pipe.

Structure Integrating Pump with Container

If small stirring blades 5s are set at the axis of the rotating container, the small stirring blades can combine with an appropriate fixed inlet pipe T to form a centrifugal pump structure, which facilitate the fluid input. FIG. 31 shows an embodiment of a rotating container with small stirring blades 5s. In the figure, a centrifugal pump structure constitutes of the small stirring blades 5s and the fixed inlet pipe T can be seen. Of course, instead of applying this separate installation, the small stirring blades 5s can also be extended out from the main stirring blades 5.

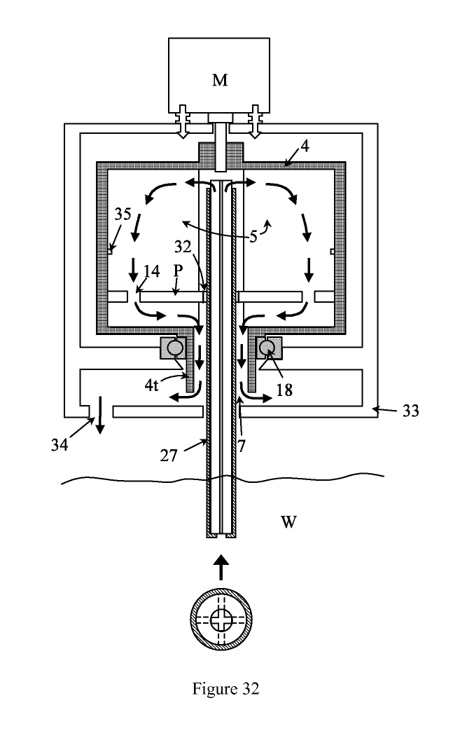

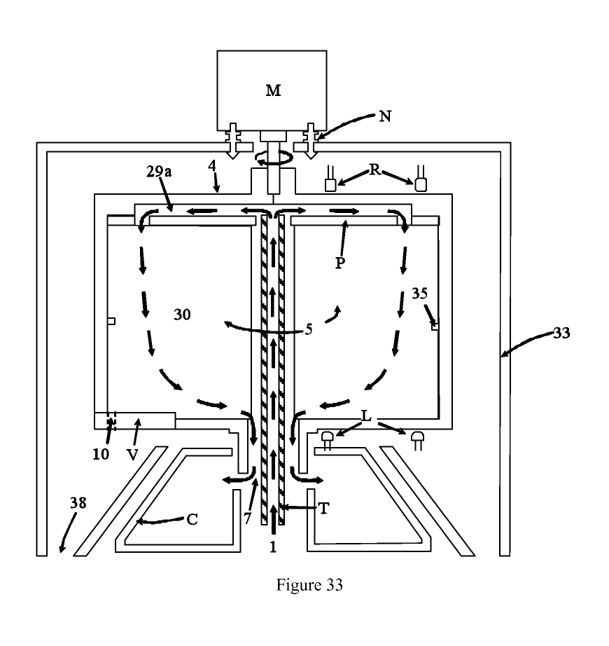

When the rotating container is operated above a water tank, beside combining a pump with the rotating container by the aforementioned method, one may also implement the water input pump by means of a synchronous centrifugal pump 27 FIG. 32 shows an embodiment of a liquid purification device with a synchronous centrifugal pump 27. When the rotating container 4 rotates, the synchronous centrifugal pump 27 will rotate synchronously. The water in the water tank W under the fluid filtration device will be pumped into the rotating container 4. Meanwhile, the air in the rotating container can be discharged from the air vent 32. At the bottom of the figure, a bottom view of the synchronous centrifugal pump 27 is shown. Its structure is very simple: stirring blades are set in a cylindrical pipe (In this example, there are a total of four stirring blades). A round cover with a center hole is set at the water inlet side.

In addition to the rotating container 4, the presently claimed invention also includes a purifier derived from the rotating container 4.

### Example 1 of Purifier

### Seawater and Oil Separator

FIG. 33 shows an embodiment of a seawater and oil separator. The structure of the rotating container 4 in this embodiment is similar to the rotating container 4 in the embodiment of FIG. 7. The rotating container 4 is made of transparent material, and directly driven by a motor M. The motor M is fixed on the shell 33 of the purifier using vibration-dampening rubber rivet N. In order to decide whether to discharge seawater or oil, a combination of two photosensitive elements is used to measure the oil and seawater in the container. The photosensitive elements pair (comprised of light source L and photosensitive elements R) is of transmission type. If not blocked, the light source L can be received by the photosensitive elements R. All the signals received by the photosensitive elements R are subjected to lowpass filtering to reduce any influence brings about by the possible oil storage in the flexible valve V and the inlet pipe 29a (see the indication in FIG. 7). In this example, the oil is discharged from the outlet port 7, whereas the seawater is discharged from the drain hole 10. It is assumed that the transparency of seawater is higher than that of oil (crude oil). When the light sensed by the two photosensitive elements R is blocked, it indicates that the container is almost full of oil, and the oil discharge procedure shall proceed, that is, to continue injecting seawater and rotate at low speed to avoid the control valve V open. The oil gathered in the inner ring will be discharged from the outlet port 7. Once light can be sensed by the two photosensitive elements R again, the seawater discharge procedure begins, that is, to rotate at high speed to open the flexible discharge valve V. The purified seawater will be discharged from the water outlet 38 on the shell of the purifier, whereas the oil is collected in the collection container C. For the structure and principle of the flexible discharge valve (V), please refer to the embodiments of FIGS. 27-29. Of course, for some oils which are transparent, but is significantly different from seawater in color, a light filter may be added in front of the two photosensitive elements R, so as to increase their resolving power to distinguish between seawater and oil. For example, if the oil is yellow like peanut oil and the light source L is white, a light filter which can filter out yellow light should be chosen. Hence, a strong light sensing value corresponds to seawater, and a weak light sensing value corresponds to oil. Of course, to achieve automation, one can make use of a microcontroller unit (MCU). This technique can easily be practiced by an ordinarily skilled person in the art.

In this embodiment, it should also be noted that the type of rotating container 4 is very important. In the case that the inlet pipe 29a is replaced with a larger inlet chamber 29, the rate at which oil gathers in the inner ring region of the inlet chamber 29 will be higher than that in the outlet chamber 30, consequently the values obtained by the photosensitive elements R cannot correctly reflect the actual situation of the outlet chamber 30, and wrong decision will be made.

### Example 2 of Purifier

### External Hanging Type Water Purifier

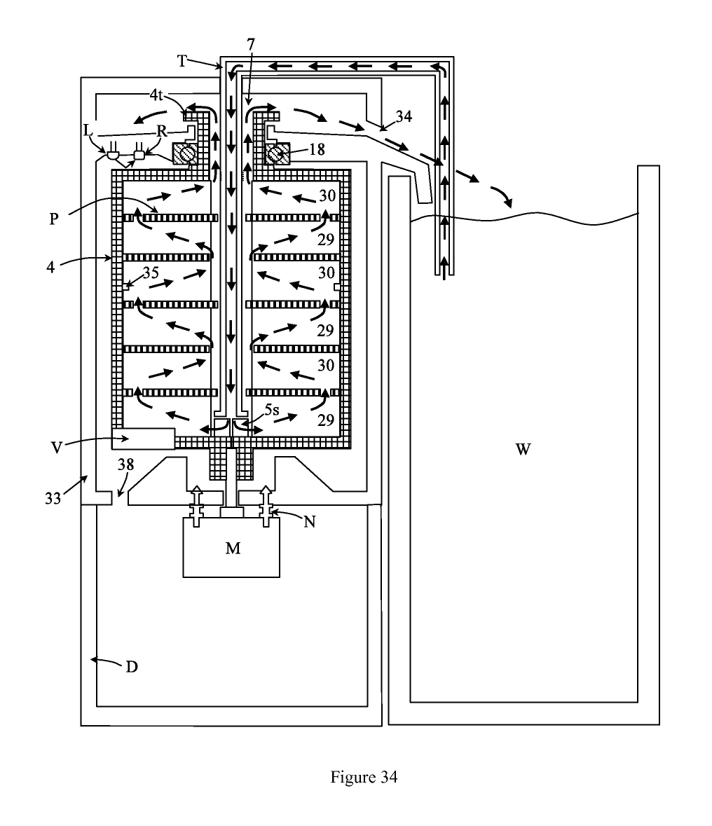

FIG. 34 shows an embodiment of an external hanging type water purifier. The top cover of its rotating container 4 is made of transparent material, and the uppermost flow-return partition P is made of white material, so that the light from the light source L can be reflected back to the photosensitive element R. The rotating container adopts the Category B serial multi-chamber design, and has small stirring blades 5s. A centrifugal pump structure is constituted of the small stirring blades 5s and the fixed inlet pipe T that is fixed at the top of the purifier. The fixed inlet pipe T is of inverted-U shape, and can also make use of the siphon effect to draw water from the water tank W. In other words, even without the small stirring blades 5s, once siphon action is established, the water can be infused automatically. A heavy impurity collection container D is hung under the shell 33 of the purifier. Heavy impurities are discharged from the flexible valve V and reach the heavy impurity collection container D via the heavy impurity outlet 38 of the purifier. In order to achieve automatic discharge, a reflective-type photosensitive element combination is installed. The output signal of the photosensitive element R is filtered by a low-pass filter, and then input to a microcontroller unit with a comparison circuit (not shown). The rotational speed of the motor M is also controlled by the microcontroller unit. The detailed operation is as follows: suppose the heavy impurities gathered in the rotating container 4 are dark: if the value sensed by the photosensitive element R corresponds to the dark heavy impurities, the procedure for discharging the heavy impurities in the container will be started, that is, to rotate the rotating container 4 at high speed to open the flexible valve V. In this embodiment, the duration of the discharge stage can be preset.

Another feature of this embodiment, that is, if the infused water is accompanied with gas, the gas can be considered as light impurities and discharged from the outlet port 7 (If the light impurities are of liquid state, the situation is somewhat different. For details, please refer to the embodiment of FIG. 33). Its practical applications include removal of chlorine in water. For example, to decrease the chlorine in tap water when replacing water for ornamental fish breeding, etc.

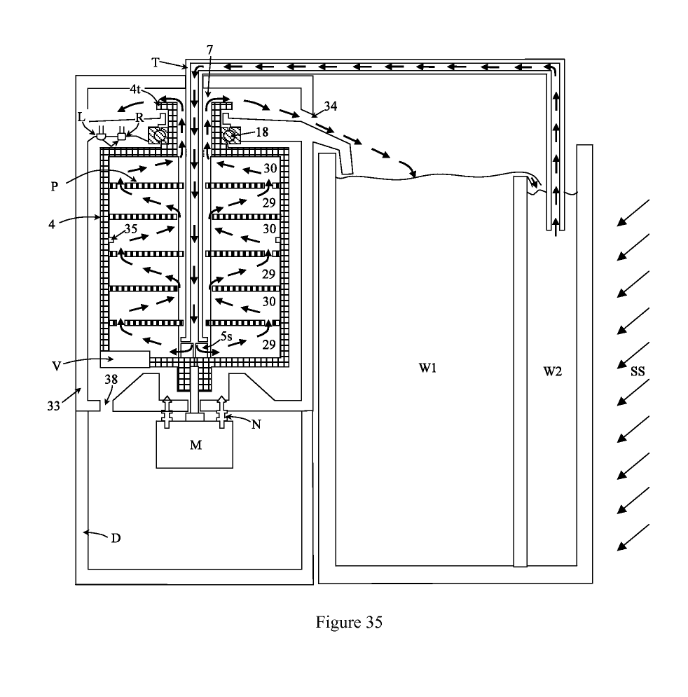

This external hanging type water purifier has a very wide range of applications. In addition to cyclic purification of water in one tank as shown in FIG. 34, it can also be combined with at least two water tanks or water tanks with partitions inside to form a self-cleaning aquaculture system. FIG. 35 illustrates this concept. In the embodiment of FIG. 35, the self-cleaning aquaculture system can be used for ornamental fish breeding at home. The external hanging type water purifier is basically the same as the embodiment shown in FIG. 34. There is a partition in the water tank, which divides the tank into two parts, that is, aquaculture tank W1 and the algae culture tank W2 as shown in the figure. It is recommended to set a simple biochemical purification system in both the aquaculture tank W1 and the algae culture tank W2, so as to change the ammonia, nitrite and other highly toxic pollutants into nitrate. In addition, the biochemical purification system in the algae culture tank W2 can also increase the carbon dioxide content in the tank. If it is necessary to further increase the rate of algae culture, additional carbon dioxide can be injected into the algae culture tank W2 or more lamps can be used to increase the illumination for the algae culture tank W2.

The aquaculture tank W1 is used to breed ornamental fish or some target aquatic products. The algae culture tank W2 is mainly used for algae culture (of course, some aquatics which are small and do not need much space can also be bred). Therefore, the algae culture tank W2 should be placed in a location close to window and often exposed to sunshine SS. At the beginning of ornamental fish breeding, you may not need to start the external hanging type purifier. After a few days or until the algae begin to breed in the container, the external hanging type purifier can be turned on intermittently, so as to exchange water between the algae culture tank W2 and the aquaculture tank W1 (The daily water exchange amount equivalent to 5-10% of the total amount of water will be enough). In this way, more nitrate, nitrite, ammonia and other nutrients required for algae culture can enter the algae culture tank W2 from the aquaculture tank W1, so as to help algae nurturing. In the end, the algae in the algae culture tank W2 will grow rapidly, and then the continuous automatic cleaning mode of the purifier can be started.

The concept of the continuous automatic cleaning mode is the use of additional photosensitive elements to measure the transmittance of water in the external hanging type water purifier (for example, the water in the fixed inlet pipe T can be detected) or directly measure the transmittance of water in the algae culture tank W2, so as to decide whether to start the external hanging type water purifier. If the transmittance is below a certain level, the external hanging type water purifier will be started. Moreover, in theory, timing method can be used to determine the algae growth conditions in the algae culture tank W2, and the method is to start the external hanging type water purifier and measure the gathering speed of heavy impurities in the rotating container. If the impurity storage space is fully filled below a certain period of time, it indicates that the purifier shall be turned on continuously (Of course, the heavy impurities in the rotating container have to be discharged first). If the impurity storage space is not fully filled within a certain period of time, the operation of the purifier should be stopped and wait for one or two days until the density of algae is sufficient. The advantage of the timing method is that no additional photosensitive element is used. Of course, the external hanging type water purifier is located beside the water tank (aquarium) in the figure merely for a clear demonstration of the operating principle of the self-cleaning aquaculture system. A better arrangement is that the water purifier should be located behind the water tank and near the partition, so as to minimize the length of the horizontal part of the fixed inlet pipe T. In this embodiment, the partition is slightly lower than the water tank. In this way, a water return passage can be formed above the partition. If the aquaculture tank W1 and the algae culture tank W2 are two independent tanks of similar height, an inverted-U-shaped pipe filled with water can be used as a siphon-type water return passage.

If a tubular water return passage is used and the end of the pipe in the aquaculture tank W1 is placed near the bottom of the aquaculture tank W1, the dirt at the bottom of the aquaculture tank W1 can be drawn into the algae culture tank W2, so that the chance for the dirt to be absorbed by algae is increased. If the algae culture tank W2 is placed in a location higher than the aquaculture tank W1, water from the aquaculture tank W1 requires to be pumped back to the algae culture tank W2, in order to maintain the water level in the aquaculture tank and to avoid overflow. To accomplish this, it is necessary to set a device that can probe the water level (e.g. water depth probe) or a water level trigger switch. In addition, it is a very appropriate choice to use a microcontroller unit (MCU) to control the operation of the self-cleaning aquaculture system.

### Example 3 of Purifier

### Top-Mounted Water Purifier

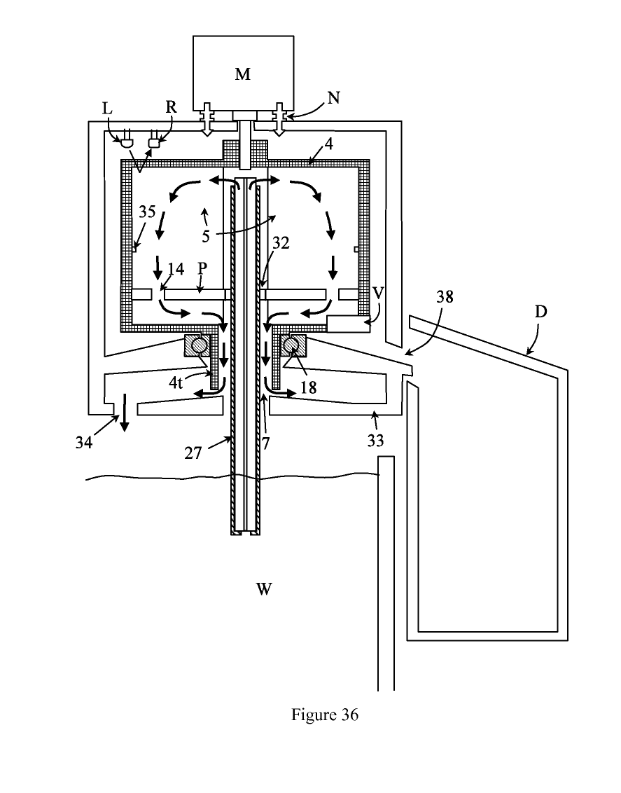

FIG. 36 shows an embodiment of a top-mounted water purifier (Although an external hanging type heavy impurity collection container D is installed, the rotating container 4 is located above the water tank W). Its structure is basically the same as that of the embodiment in FIG. 32. Its feature is that a synchronous centrifugal pump 27 is used to pump water from the water tank W. Its automatic discharge and heavy impurity collection method is basically the same as that of the embodiment in FIG. 34.

### Example 4 of Purifier

### Car Exhaust Gas Purifier

In addition to the liquid purification applications, this invention is also applicable to gas purification. For example, it can be used to remove suspended particles in car exhaust gas. The method is that the car's exhaust pipe is used as a fixed inlet pipe T. If the car's exhaust pipe is strong enough, two bearings, with inner diameter the same as the outer diameter of exhaust pipe, can be worn on the exhaust pipe and then the rotating container can be worn on this two bearings so that the rotation axis of the rotating container is aligned with that of the bearing's. Other accessories (e.g. motor) can also be placed on the exhaust pipe. If the exhaust pipe is not firm enough, a support frame to fix the purifier on the car chassis must be used. The motor and the car's internal combustion engine can be used to provide driving power.

### Example 5 of Purifier

### Reverse Osmosis Filtration System

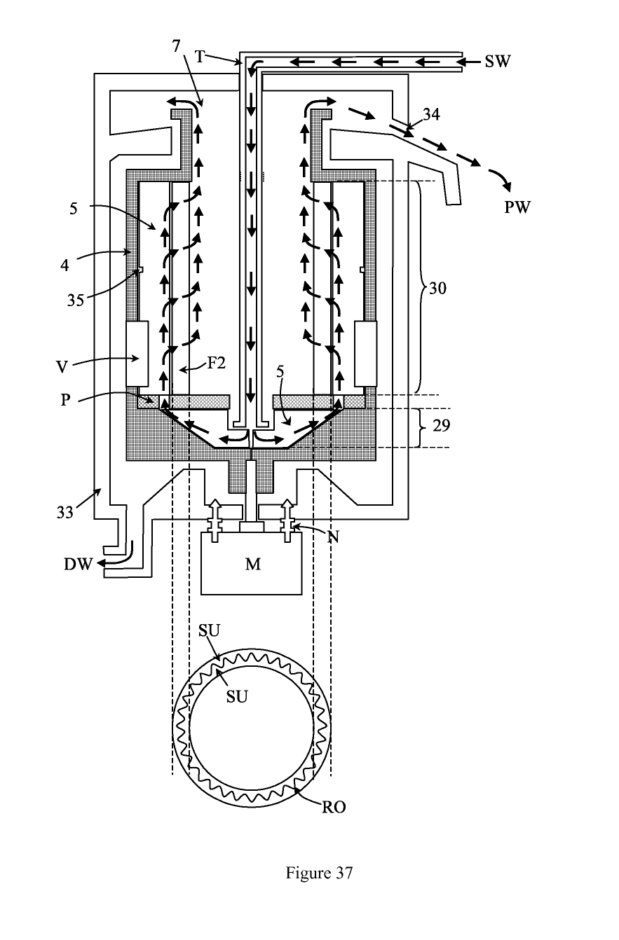

FIG. 37 shows an important embodiment of the presently claimed invention, and its rotating container is very similar to that of the embodiment of FIG. 12. Its principle is that a reverse osmosis membrane is used as filter material. In the embodiment of FIG. 37, the sectional view at the bottom of FIG. 37 shows the structure of the filter core F2. Stirring blades 5 are appropriately set in both the inlet chamber 29 and the outlet chamber 30. One important application of this invention is seawater desalination. Therefore, this document will use a seawater desalination system to elaborate its operating principle. The filter core F2 is made by putting a reverse osmosis membrane RO in a hard permeable substrate SU. This substrate SU can also provide a certain capability for physical filtration and biological filtration (bacteria culture substrate). In this embodiment, the reverse osmosis membrane RO adopts an undulant design, so as to provide a larger surface area. The water pressure required for pure water PW to pass through the reverse osmosis membrane RO is obtained via the centrifugal force generated by the rotation of the rotating container. Therefore, to obtain a higher water pressure, in addition to increasing the rotational speed, the difference between the maximum axial distance of the outlet port and the maximum axial distance of the inlet pipe installation port can also be increased in the design. Moreover, to discharge the salt water and impurities near the outer edge of the rotating container, one may increase of rotational speed or applying the aforementioned “filter core clogging” method to shift the water level closer to the rotation axis in order to increase the water pressure at the drain hole that implemented with flexible valve V. For the design of the flexible valve V, please refer to FIGS. 27-29. In this embodiment, the flexible valve V is set on the outer surface of the cylindrical rotating container. In FIG. 37, seawater SW is drawn into the rotating container, and then filtered by the filter core F2 to get pure water PW. Salt water and sewage DW containing heavy impurities are discharged via the flexible valve V. The discharge process can be continuous or intermittent. Intermittent discharge can be decided using photosensitive elements to detect the gathering of heavy impurities and the water level in the inlet chamber. Of course, if the inlet chamber is almost fully filled, that is, the infused seawater almost overflows from the inlet pipe installation port, the discharge process shall be started. With respect to continuous discharge, the water level of the inlet chamber should also be monitored, and the method of increasing the rotational speed can be used, so as to ensure that the seawater will not overflow to the outlet port 7 from the inlet pipe installation port.

In comparison with reverse osmosis system which generally adopts a high-pressure pump, the presently claimed invention has the advantages of energy saving, great efficiency (under the same water pressure, more pure water can pass through the membrane) and automatic cleaning.

Factors Influencing Purification Effect

Rotational speed: Generally, the faster, the better. As the rotating container 4 and the related mechanical parts (e.g. bearing 18) have speed limits, to achieve higher rotation speed will lead to highly costs. Therefore, the rotational speed is designed according to the centrifugal acceleration actually required in practical applications. Of course, for the same centrifugal acceleration, the rotational speed required by the rotating containers with larger diameter is lower in comparison with the rotating containers with smaller diameter. For example, in general applications to fresh water or seawater, the rotational speed from 500 rpm to 30000 rpm is more common.

Liquid 1 input rate: Generally, the slower, the better. However, the liquid input rate is equal to the liquid purification rate. Therefore, in practical applications, an acceptable purification result should be set firstly, and then the liquid input rate should be increased slowly to find the most appropriate value. In addition to continuous liquid input at constant rate, a discontinuous waveform input can also be applicable. For example, square-wave form input generally results in a better purification effect than the input at constant rate. The input in different waveforms belongs to the existing technology (for example, in its applications to liquid, the desired effect can be obtained using an electromagnetic water valve), so we will not go further here.

Effective capacity of the rotating container 4: in practice, the water storage capacity of the rotating container 4 is its effective capacity. Generally, the bigger the better. However, excessive volume will increase the costs for manufacturing, operation (such as electricity fee) and maintenance.

Motor system 19 can be an electric motor, air motor, internal combustion engine or any other existing technical equipment. It can be directly connected with the rotating container or use gears, timing belts or drive belts for power transmission. Basically, the existing technology can already achieve good result.

Liquid 1 input can be achieved through a pump 20, water pressure, siphon or other gravity driven methods. Moreover, if liquid input is achieved by a pump 20, the power for the pump 20 and the rotating container 4 can be sourced from the same motor system 19 that mentioned before. In addition to the example of liquid input via a synchronous centrifugal pump, another generally applicable method is to make use of direct connection (e.g. if the rotation axes of the rotating container and that of the motor system's are aligned), or the indirect connection methods, accomplished by gears, timing belts or driving belts, to distribute power from the motor system 19 to the pump 20 and the rotating container 4 simultaneously. This arrangement can effectively reduce manufacturing and maintenance costs.

The foregoing description of the presently claimed invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A rotating container, characterized in that it comprises:
a shell, the said shell has an inlet pipe installation port and an outlet port, the said inlet pipe installation port and the said outlet port are located on same or opposite side of the said shell, and have some distance from an outermost edge of the said shell, so that the said rotating container can store water during rotation; wherein maximum shaft distance of the outlet port is larger than that of the said inlet pipe installation port; if the said inlet pipe installation port and the said outlet port are located on the same side (end) of the said shell, they are either separately implemented or combined into one combined port where fluid is discharged from the said combined port near the outer edge; and
stirring blades or filter core being placed inside the shell of the said rotating container, which rotate with the said shell around the said rotating shaft synchronously.

2. The rotating container of claim 1, characterized in that the said outlet port or the said combination opening is surrounded by the outlet port sleeve extended from the said shell of the said rotating container.

3. The rotating container of claim 1, characterized in that the said stirring blades are planar or curved.

4. The rotating container of claim 1, characterized in that the said stirring blades are spiral.

5. The rotating container of claim 1, characterized in that a flow-return partition in the said rotating container separates the chamber of the said rotating container into inlet chamber and outlet chamber;
wherein the said flow-return partition has a flow-return opening or a flow-return opening is formed, and a central opening is formed near the position of the said rotating shaft; and
wherein the maximum shaft distance of the said central opening is smaller than that of the said outlet port, so that the fluid will not flow from the said inlet chamber to the said outlet chamber via the said central opening during operation.

6. The rotating container of claim 1, characterized in that an outlet pipe or an outlet passage structure is set in the said rotating container, opening at one end of the said outlet pipe or the said outlet passage structure is located in a position near the periphery of the said rotating container, while another end is connected to the said outlet port.

7. The rotating container of claim 5, characterized in that the said inlet chamber is replaced with a pipe or inlet passage structure, so that the fluid flows from the said port for placing inlet pipe to a position near the periphery of the said rotating container via the said inlet pipe or the said inlet passage structure.

8. The rotating container of claim 5, characterized in that the said outlet chamber is replaced with a pipe or an outlet passage structure, so that the fluid flows from a position near the periphery of the said rotating container to the said outlet port via the said pipe or the said outlet passage structure.

9. A multi-chamber rotating container, characterized in that it is equivalent to one or more of the said chamber structures of claims 6-8 being connected together to form a multi-chamber structure, wherein the said chamber structures of a multi-chamber structure are connected in series or in parallel; wherein in the case of parallel connection, the said outlet chambers or the said outlet pipes or the said outlet passage structures will be interconnected, and the fluid in them will be drawn to the position near the edge of the said outlet port or the said combination opening, whereas the fluid will be distributed to the said inlet chambers or the said inlet pipes or the said inlet passage structures via the fixed inlet pipe or the synchronous inlet pipe; wherein in the case of series connection, except that the fluid in the said outlet chamber or the said outlet pipe or the said outlet passage structure closest to the said outlet port is directly discharged through the said outlet port, the fluid in other said outlet chambers or the said outlet pipes or the said outlet passage structures will be drawn to the adjacent said inlet chamber or the said inlet pipe or the said inlet passage structure.

10. The rotating container of claim 1, characterized in that small stirring blades are set in a position around the rotating shaft at one end of the said rotating container, which combine with the fixed inlet pipe located in the said rotating shaft to form a centrifugal pump structure;
Wherein, the said small stirring blades are installed separately or extended out from the said stirring blades.

11. The rotating container of claim 1, characterized in that baffle plate is set in the said rotating container, the said baffle plate has at least one impurity outlet passage, and an impurity storage space is formed between the said shell and the said baffle plate.

12. The rotating container of claim 11, characterized in that under the circumstances that the said stirring blade is curved or spiral, an impurity outlet passage is set at the outer end of the said stirring blade away from the said rotating shaft, so that the impurities settled on the said stirring blade can be discharged to the said impurity storage space.

13. The rotating container of claim 11, characterized in that the opening of the impurity outlet passage near the said rotating shaft is bigger than that near the impurity storage space.

14. The rotating container of claim 5, characterized in that if the said flow-return partitions connect with the said shell, a through hole for heavy impurities can be set on the outermost edge of the said flow-return partitions, so as to optimize the distribution of the heavy impurities in the inlet chamber and the outlet chamber.

15. The rotating container of claim 1, characterized in that the said stirring blades connect with the said shell, and through holes for passing heavy impurities are set on the outermost edge of the said stirring blades.

16. The rotating container of claim 1, characterized in that drain holes which can be opened/closed are set near the periphery of the shell of the said rotating container.

17. The rotating container of claim 16, characterized in that a drain tube near the periphery of the said rotating container is used to draw the heavy impurities near the periphery to the drain hole near the said rotating shaft for discharge.

18. The rotating container of claim 16, characterized in that the said drain hole is opened/closed manually or installed with a flexible valve; the said flexible valve is controlled via the rotational speed of the said rotating container, electromagnetic force or the radial water level of the inlet chamber of the said rotating container.

19. The rotating container of claim 18, characterized in that the said flexible valve is of level type or piston type.

20. The rotating container of claim 1, characterized in that there is a synchronous inlet pipe in the position of the said rotating shaft, which is a multi-hole pipe, so as to distribute the liquid to different inlet chambers via different holes or optimize the amount of liquid infused into different inlet chambers; the said synchronous inlet pipe and the said rotating container rotate synchronously.

21. A synchronous centrifugal pump structure, characterized in that its structure is that stirring blades are installed in the circular symmetric tube, one end of the said circular symmetric tube has a circular cover, the said circular cover has a hole in the center for fluid inflow, the said circular symmetric tube, the said circular cover and the said stirring blades rotate simultaneously.

22. A fluid filtration device, characterized in that it includes the said rotating container of claim 1 as well as:
the shell or support structure fixing the said rotating structure; and
the fixed inlet pipe fixed on the said shell or the said support structure or a synchronous centrifugal pump formed according to claim 21, which is used for liquid input purpose; and
the rotary actuator driving the said rotating container.

23. The fluid filtration device of claim 22, characterized in that the said rotating container has the said flexible valve; the said fluid filtration device also includes a heavy impurity collection container to contain the heavy impurities discharged from the said rotating container.

24. The fluid filtration device of claim 22, characterized in that it also includes a liquid-state light impurity collection container to contain the liquid-state light impurities discharged from the said outlet port or the said combination opening of the said rotating container; the said liquid-state light impurities are lighter than the purified liquid.

25. The fluid filtration device of claim 22, characterized in that either:
the one end of the said rotating container is made of transparent material; photosensitive elements or reflective-type photosensitive elements with light source are installed at this transparent end, so as to detect the gathering of the said heavy impurities and decide whether to discharge the heavy impurities; or
both ends of the said rotating container are made of transparent material; photosensitive element and light source are installed at both ends respectively, so as to detect the gathering of the said heavy impurities and decide whether to discharge the heavy impurities.

26. A self-cleaning aquaculture system, characterized in that it includes at least one said filtration device of claim 25, which works with at least one algae culture tank and at least one aquaculture tank; water from the algae culture tank being infused into the said filtration device and drain the filtered water to the said aquaculture tank; and a water return passage between the said algae culture tank and the aquaculture tank, enabling the water in the aquaculture tank water to flow back into the algae culture tank.

27. The self-cleaning aquaculture system of claim 26, characterized in that there are lamps near the said algae culture tank to increase the illumination for the said algae culture tank.

28. The self-cleaning aquaculture system of claim 26, characterized in that the said algae culture tank is installed with a carbon dioxide injection device.

29. The self-cleaning aquaculture system of claim 26, characterized in that the said aquaculture tank is placed in a location lower than the algae culture tank, and the water in the said aquaculture tank is pumped back to the algae culture tank via the said water return passage, so as to maintain the water level in the said aquaculture tank and avoid overflow.

30. The self-cleaning aquaculture system of claim 26, characterized in that photosensitive elements are set to measure the transmittance of the water in the said filtration device or the water in the said algae culture tank.

31. The self-cleaning aquaculture system of claim 26, characterized in that the said aquaculture tank or the said algae culture tank is installed with a biological purifier, so as to adjust the content of ammonia and nitrite in the said self-cleaning aquaculture system.

32. A reverse osmosis filtration system, characterized in that it includes a rotating container with the said filter core according to claim 1, and the said filter core includes a reverse osmosis membrane.
